(19) United States
(12) Patent Application Publication
(10) Pub. No.: US 2009/0261649 A1
(43) Pub. Date: Oct. 22, 2009

(54) Brake Booster

(76) Inventors: Motohiro Higuma, Atsugi-shi (JP); Kazuya Yamano, Atsugi-shi (JP); Takanobu Saito, Kamakura-shi (JP); Satoru Kuragaki, Isehara-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/382,719

(22) Filed: Mar. 23, 2009

(30) Foreign Application Priority Data
Apr. 3, 2008 (JP) 097117/2008

(51) Int. Cl. B60T 8/34

(52) U.S. Cl. 303/113.3

(57) ABSTRACT

The present invention provides a brake booster in which an excellent pedal feeling can be provided even though a brake fluid pressure control unit is disposed between the brake booster and a wheel cylinder. The brake booster according to the present invention performs different methods for controlling a booster based on whether the fluid pressure control unit is in operation, and controls a displacement amount of an assist member so that a change in a master cylinder pressure is within a predetermined range even when the fluid pressure control unit is in operation.

### BACKGROUND OF THE INVENTION

The present invention relates to a brake booster capable of providing an assist power to an operation of a brake pedal.

Japanese Patent Application Public Disclosure No. 2007-112426 discloses an invention comprising an input member and an assist member which change a volume of the inside of a master cylinder, and displacing the assist member according to the displacement of the input member caused by an operation of a brake pedal. In this invention, the volume of the inside of the master cylinder is changed by the displacement of the assist member in addition to the brake pedal operation, whereby providing an assist force at the time of a brake pedal operation, i.e., a boosting mechanism can be achieved.

On the other hand, there is the following problem with a vehicle in which a brake fluid pressure control unit capable of carrying out the anti-lock brake control and the like is disposed between a brake booster and an wheel cylinder. In the anti-lock brake control, the brake fluid pressure in the wheel cylinder is pressurized or depressurized according to a slip condition of a tire. In particular, the brake fluid is supplied from the master cylinder to the wheel cylinder during pressurization, while the brake fluid is discharged from the wheel cylinder to a reservoir during depressurization. The brake fluid saved in the reservoir back-flows to the master cylinder with the aid of a pump.

At this time, a change in the brake fluid is caused in the master cylinder regardless of brake pedal operation, which causes strokes of the input member and assist member. As mentioned above, since the displacement of the assist member is controlled according to the displacement of the input member under the boosting control, the displacement of the input member and the assist member by a disturbance other than the displacement of the input member caused by a brake pedal operation may lead to vibration of the system and a divergent control, resulting in pulsation and pedal vibration.

In addition, the amount of the brake fluid back-flowing to the master cylinder side varies according to a depressurized amount and the like, and the brake fluid back-flowing operation the depressurization operation is intermittently performed, whereby a reactive force acting on the brake pedal does not become constant, and therefore a driver may have a strange and discomfort feeling.

### SUMMARY OF THE INVENTION

The present invention has been contrived in consideration of the above-mentioned problems, and an object thereof is to provide a brake booster capable of providing an excellent pedal feeling even though a brake fluid pressure control unit is disposed between the brake booster and a wheel cylinder.

To achieve the forgoing and other objects, the present invention provides a brake booster, comprising: an assist member disposed so as to be movable relative to an input member movable forward and backward according to an operation of a brake pedal; an urging member operable to urge the input member relative to the assist member to a neutral position of relative displacement between the assist member and the input member; a booster operable to pressurize an inside of a master cylinder by displacing the assist member; a control unit operable to control an actuator operable to drive the assist member according to a predetermined input signal; and a fluid pressure control unit disposed between the master cylinder and a wheel cylinder, wherein the control unit switches a type of the predetermined input signal for driving the actuator according to an operation condition of the fluid pressure control unit.

### BRIEF DESCRIPTION OF THE DRAWINGS

FIG. 1 is a schematic diagram illustrating an overall configuration of a brake control apparatus according to a first embodiment;

FIG. 2 is a block diagram illustrating a control configuration of the first embodiment;

FIG. 3 is a flow chart illustrating a basic control configuration of an assist member passive control in the first embodiment;

FIG. 4A is a diagram showing the relationship between an input member absolute displacement amount and an assist member absolute displacement amount regarding a boosting ratio in the first embodiment;

FIG. 4B is a diagram showing the relationship between the input member absolute displacement amount and a relative displacement amount regarding the boosting ratio;

FIG. 4C is a diagram showing the relationship between the input member absolute displacement amount and a master cylinder fluid pressure regarding the boosting ratio.

FIG. 5 is a flow chart of a basic control configuration of an assist member active control in the first embodiment;

FIG. 6 is a flow chart of a pedal displacement amount calculating process in the first embodiment;

FIG. 7 is a flow chart of an assist member absolute displacement amount storing process in the first embodiment;

FIG. 8 is a flow chart of an active control target value setting process in the first embodiment;

FIG. 9 is a flow chart of a control switch process performed at a pedal initial displacement storing unit, a comparison unit and a switch unit in the first embodiment;

FIG. 10 is a flow chart of a pedal initial displacement detecting process in the first embodiment;

FIG. 11 is a time chart illustrating the assist member active control when the ABS control is in operation in the first embodiment;

FIG. 12 is a block diagram illustrating a control configuration of the second embodiment;

FIG. 13 is a flow chart of a basic control configuration of an assist member active control in the second embodiment;

FIG. 14 is a flow chart of a master cylinder pressure storing process in the second embodiment;

FIG. 15 is a flow chart of an active control target value setting process in the second embodiment; and

FIG. 16 is a time chart illustrating the assist member active control when the ABS control is in operation in the second embodiment.

### DETAILED DESCRIPTION OF THE INVENTION

Hereinafter, best modes for carrying out the brake control apparatus of the present invention will be described with reference to the accompanying drawings

### First Embodiment

### Configuration of Brake Control Apparatus

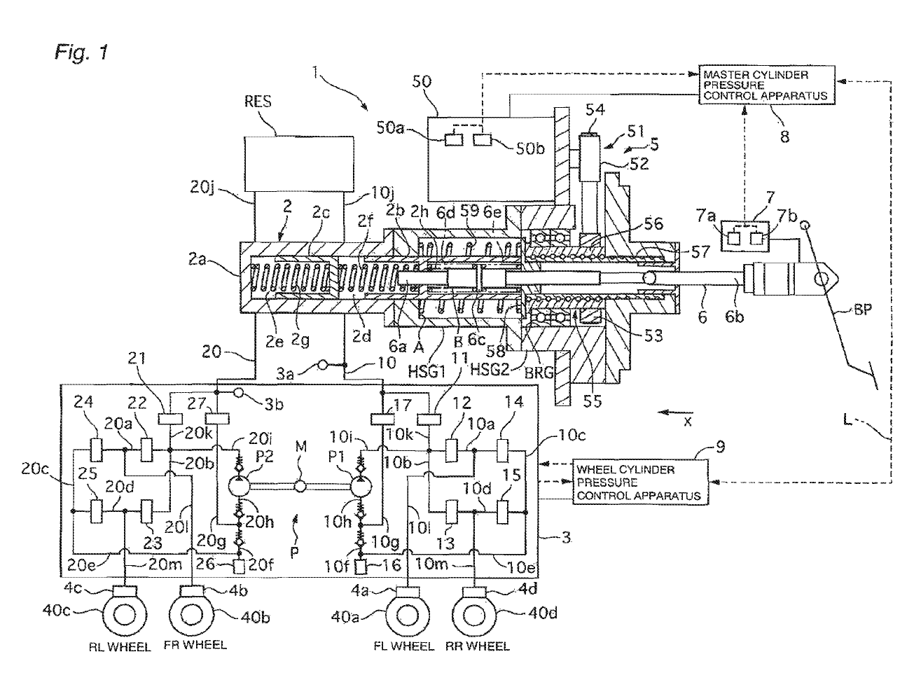

FIG. 1 shows an overall configuration of a brake control apparatus 1 according to a first embodiment of the present invention. “FL wheel” is a front left wheel, “FR wheel” is a front right wheel, “RL wheel” is a rear left wheel, and “RR wheel” is a rear right wheel. The arrowed broken line is a signal line, and the direction of the arrow indicates the direction of a flow of a signal.

The brake control apparatus 1 comprises a master cylinder 2, a reservoir tank RES, a wheel cylinder pressure control mechanism 3, wheel cylinders 4a to 4d mounted on the FL, FR, RL, and RR wheels, a master cylinder pressure control mechanism 5 and an input rod 6 mounted so as to be connected to the master cylinder 2, a brake operation amount detecting apparatus 7, a master cylinder pressure control apparatus 8 for controlling the master pressure control mechanism 5, and a wheel cylinder pressure control apparatus 9 for controlling the wheel cylinder pressure control mechanism 3.

The input rod 6 moves forward or backward according to depression or return of a brake pedal BP so as to increase or decrease a pressure (hereinafter referred to as “master cylinder pressure Pmc) in the master cylinder 2. The master cylinder pressure control mechanism 5 and the master cylinder pressure control apparatus 8 are operable to increase or decrease the master cylinder pressure Pmc by controlling a primary piston 2b of the master cylinder 2.

Hereinafter, for convenience of description, the axial direction of the master cylinder 2 is referred to as “x axis”, and the side of the brake pedal BP is referred to as “negative direction”. Now, the master cylinder 2 is so called a tandem-type master cylinder, and includes the primary piston 2b and a secondary piston 2c in a cylinder 2a. A primary fluid chamber 2d as a pressurization chamber is defined by an inner circumferential surface of the cylinder 2a and a surface of the x axis positive direction side of the primary piston 2b, and a surface of the x axis negative direction side of the secondary piston 2c. A secondary fluid chamber 2e as a pressurization chamber is defined by the inner circumferential surface of the cylinder 2a and a surface of the x axis positive direction side of the secondary piston 2c.

The primary fluid chamber 2d is communicably connected to a brake circuit 10. The secondary fluid chamber 2e is communicably connected to a brake circuit 20. The volume of the primary fluid chamber 2d is changed when the primary piston 2b and the secondary piston 2c slide in the cylinder 2a. A return spring 2f for urging the primary piston 2b to the x axis negative direction side is disposed in the primary fluid chamber 2d. The volume of the secondary fluid chamber 2e is changed when the secondary piston 2c slides in the cylinder 2a. A return spring 2g for urging the secondary piston 2c to the x axis negative direction side is disposed in the secondary fluid chamber 2e.

One end 6a of the input rod 6 on the x axis positive direction side extends through a partition wall 2h of the primary piston 2b into the primary fluid chamber 2d. While seal and liquid-tightness are provided between the one end 6a of the input rod 6 and the partition wall 2h of the primary piston 2b, the one end 6a is disposed through the partition wall 2h so as to be slidable in the x axis direction. On the other hand, the other end 6b of the input rod 6 on the x axis negative direction side is coupled to the brake pedal BP. Upon depression of the brake pedal BP, the input rod 6 moves to the x axis positive direction side, and upon return of the brake pedal BP, the input rod 6 moves to the x axis negative direction side.

Hydraulic fluid in the primary fluid chamber 2d is pressurized when the input rod 6 or the primary piston 2b (driven by a driving motor 50) moves to the x axis positive direction side. The pressurized hydraulic fluid is supplied to the wheel cylinder pressure control mechanism 3 via the brake circuit 10. In addition, the secondary piston 2c moves to the x axis positive direction side due to the pressurized pressure in the primary fluid chamber 2d. Hydraulic fluid in the secondary fluid chamber 2e is pressurized due to the above-mentioned forward movement of the secondary piston 2c, and is supplied to the wheel cylinder pressure control mechanism 3 via the brake circuit 20.

In this way, the input rod 6 moves according to a movement of the brake pedal BP, and pressurizes the primary fluid chamber 2d. Therefore, even through the driving motor 50 stops due to a failure, the master cylinder pressure Pmc can be increased by driver's brake operation, and a predetermined brake force can be generated. Further, since a force according to the master cylinder pressure Pmc acts on the brake pedal BP through the input pot 6, and is transmitted to the driver as a brake pedal reactive force, a spring or other members for generating a brake pedal reactive force is not necessary which otherwise would be required. Therefore, it is possible to reduce a size and a weight of brake control apparatus, and therefore improve mountability thereof to a vehicle.

The brake operation amount detecting apparatus 7 is disposed on the other end 6b side of the input rod 6 for detecting a brake force which a driver requests. The brake operation amount detecting apparatus 7 is a displacement sensor (stroke sensor of the brake pedal BP) for detecting a displacement amount in the x axis direction, which is a stroke amount of the input rod 6. In the first embodiment, two displacement sensors 7a and 7b are provided, and each of the displacement amounts detected by them is input in the master cylinder pressure control apparatus 8. In this way, since a plurality of displacement sensors are used in combination, even though a signal is not output from one of the sensors due to a failure, the rest of them can detect and recognize driver's brake request so that fail safe is realized.

The brake operation amount detecting apparatus 7 may be embodied by a pressing force sensor for detecting a force pressing the brake pedal BP, or a combination of a stroke sensor and a pressing force sensor.

The reservoir tank RES includes at least two fluid chambers divided by a partition wall. The fluid chambers are communicably connected to the primary fluid chamber 2d and the secondary fluid chamber 2e of the master cylinder 2 through brake circuits 10j and 20j, respectively.

The wheel cylinder pressure control mechanism 3 is a fluid pressure control unit operable to perform the ABS control and the vehicle stability assist control and the like, and supplies the hydraulic fluid pressurized in the master cylinder 2 and the like into the wheel cylinders 4a to 4d according to a control instruction of the wheel cylinder pressure control apparatus 9.

The wheel cylinders 4a to 4d each include a cylinder, a piston and a pad and the like. They each are a known wheel cylinder in which the piston moves forward by receiving the hydraulic fluid supplied from the wheel cylinder pressure control mechanism 3, and the pad coupled to the piston is pressed against disk rotors 40a to 40d. The disk rotors 40a to 40d respectively rotate integrally with the wheels FL, FR, RL, RR, and the brake torques acting on the disk rotors 40a to 40d become brake forces which act between the wheels FL, FR, RL, RR and the road surface.

The master cylinder pressure control mechanism 5 controls a displacement amount of the primary piston 2b, i.e., the master cylinder pressure Pmc according to a control instruction of the master cylinder pressure control apparatus 8. The master cylinder pressure control mechanism 5 comprises the driving motor 50, a speed reducing apparatus 51, and a rotation-linear motion converting apparatus 55.

The master cylinder pressure control apparatus 8 is an arithmetic processing unit, and controls an operation of the driving motor 50 based on sensor signals from the brake operation amount detecting apparatus 7 and the driving motor 50, a signal from the wheel cylinder pressure control apparatus 9 which will be described below, and the like.

The wheel cylinder pressure control apparatus 9 is an arithmetic processing unit, and calculates target brake forces to be generated at the wheels FL, FR, RL, RR, based on a distance to the preceding car, road information, and vehicle condition information (for example, a yaw rate, a longitudinal acceleration, a lateral acceleration, a handle rudder angle, a wheel speed, and a vehicle body speed). The wheel cylinder pressure control apparatus 9 controls operations of actuators (solenoid valves and pumps) of the wheel cylinder pressure control mechanism 3, based on the calculation result.

The master cylinder pressure control apparatus 8 and the wheel cylinder pressure control apparatus 9 are connected through a signal line L and are communicable with each other.

### [Wheel Cylinder Pressure Control Mechanism]

A hydraulic circuit of the wheel cylinder pressure control mechanism 3 will now be described.

The brake circuit has two separate brake systems, and is divided into a primary system and a secondary system. The primary system receives a supply of hydraulic fluid from the primary fluid chamber 2d, and controls brake forces for the FL wheel and the RR wheel through the brake circuit 10. The secondary system receives a supply of hydraulic fluid from the secondary fluid chamber 2e, and controls brake forces for the FR wheel and RL wheel through the brake circuit 20. Since a X-type configuration is employed in this way, even though a failure occurs in one of the brake systems, diagonal two wheels can have normal brake forces due to the other normal one of the brake systems so that the stable behavior of the vehicle can be maintained. In the following, description about the primary system will be provided, although this is also applicable to the secondary system.

An out-side gate valve 11 is disposed on the way from the master cylinder 2 side (hereinafter referred to as “upstream side”) of the brake circuit 10 to the wheel cylinder 4a and 4d side (hereinafter referred to as “downstream side”). The out-side gate valve 11 opens when the hydraulic fluid pressurized in the master cylinder 2 is supplied into the wheel cylinder 4a and 4d.

A brake circuit 10k where the out-side gate valve 11 is disposed branches into brake circuits 10a and 10b on the downstream side thereof. The brake circuits 10a and 10b are respectively connected to the wheel cylinders 4a and 4d through the brake circuit 10l and 10m. Pressure-increasing valves 12 and 13 are disposed at the brake circuits 10a and 10b, respectively. The pressure-increasing valves 12 and 13 open when the hydraulic fluid pressurized in the master cylinder 2 or a pump P which will be described later is supplied to the wheel cylinders 4a and 4d.

Return circuits 10c and 10d are respectively connected to the brake circuits 10a and 10b on the downstream side of the pressure-increasing valves 12 and 13. Pressure-decreasing valves 14 and 15 are respectively disposed at the return circuits 10c and 10d. The pressure-decreasing valves 14 and 15 open when the pressures (hereinafter referred to as “wheel cylinder pressure Pwc”) in the wheel cylinders 4a and 4d are reduced. The return circuits 10c and 10d are joined to form a return circuit 10e, which is connected to the reservoir 16.

On the other hand, the brake circuit 10 branches on the upstream side of the out-side gate valve 11 to form a suction circuit 10g. An in-side gate valve 17 for switch between establishing communication and blocking communication of the suction circuit 10g is disposed at the suction circuit 10g. For example, the in-side gate valve 17 opens when the hydraulic fluid pressurized in the master cylinder 2 is further pressurized by the pump p which will be described below and is supplied to the wheel cylinders 4a and 4d. The suction circuit 10g is joined with the return circuit 10f extending from the reservoir 16 to form a suction circuit 10h.

The pump P operable to suck and discharge hydraulic fluid is connected to the brake circuit 10 as a fluid pressure source other than the master cylinder 2. The pump P is a plunger type or gear type pump, and comprises a first pump P1 and a second pump P2. For example, the pump P pressurizes the master cylinder pressure Pmc and supplies it to the wheel cylinders 4a and 4d when an automatic brake control such as the vehicle stability assist control is performed and a pressure exceeding the hydraulic pressure of the master cylinder 2 is required. The first pump P1 is connected to the suction circuit 10h and a discharge circuit 10i, and is connected to the brake circuit 10k through the discharge circuit 10i.

A motor M is a DC (direct current) brushless motor or a DC brush motor, and an output shaft thereof is coupled with the pumps P1 and P2. The motor M is actuated by an electric current supplied based on a control instruction of the wheel cylinder pressure control apparatus 9, and drives the pumps P1 and P2.

The out-side gate valve 11, the in-side gate valve 17, the pressure-increasing valves 12 and 13, and the pressure-decreasing valves 14 and 15 are electromagnetic valves opening and closing by application of an electric current to the solenoid. Valve-opening degrees of the respective valves are independently controlled by application of a driving electric current according to a driving signal output from the wheel cylinder pressure control apparatus 9.

The out-side gate valve 11 and the pressure-increasing valves 12 and 13 are normally open, and the in-side gate valve 17 and the pressure-decreasing valves 14 and 15 are normally closed. As a result, even if a supply of an electric current to any of the valves is stopped due to a failure, all of the hydraulic fluid pressurized in the master cylinder 2 can reach the wheel cylinders 4a and 4d, so that a brake force can be generated according to a request of a driver.

The hydraulic circuit of the brake circuit 20 side has a similar configuration to that of the above-mentioned brake circuit 10 side.

Master cylinder pressure sensors 3a and 3b for detecting the master cylinder pressure Pmc (pressures in the primary fluid chamber 2d and the secondary fluid chamber 2e) are respectively disposed at the brake circuit 10 (between the master cylinder 2 and the wheel cylinder pressure control mechanism 3), and the brake circuit 20 (in the wheel cylinder pressure control mechanism 3). The information of the master cylinder pressure Pmc detected by the master cylinder pressure sensors 3a and 3b is input to the master cylinder pressure control apparatus 8 and the wheel cylinder pressure control apparatus 9. The number of master cylinder pressure sensors installed and the positions thereof may be freely decided in consideration of, for example, controllability and fail safe.

When the brake is in operation, the wheel cylinder pressure control mechanism 3 functions as follows. When the brake is in operation as a normal braking operation, the hydraulic fluid in the master cylinder 2 is supplied to the wheel cylinders 4a to d through the brake circuit 10 and 20, and a braking force is generated.

When the ABS control is performed, taking the wheel FL as an example, the pressure-decreasing valve 14 connected to the wheel cylinder 4a is opened and the pressure-increasing valve 12 is closed, and the hydraulic fluid in the wheel cylinder 4a is returned to the reservoir 16, so that the pressure therein is reduced. When the wheel FL recovers to the normal condition from the locked condition, the pressure-increasing valve 12 is opened and the pressure-decreasing valve 14 is closed, so that the pressure therein is increased. At this time, the hydraulic fluid released to the reservoir 16 is returned to the brake circuit 10k with the aid of the pump P.

When an automatic brake control such as the vehicle stability assist control is performed, the out-side gate valves 11 and 21 are closed, and the in-side gate valves 17 and 27 are opened. At the same time, the pump P is actuated so that the hydraulic fluid is discharged from the master cylinder 2 to the brake circuits 10k and 20k through the suction circuits 10g, 10h, 20g and 20h, and the discharge circuit 10i and 20i. In addition, the out-side gate valves 11 and 21 and the pressure-increasing valves 12, 13, 22 and 23 are controlled such that the wheel cylinder pressure Pwc becomes equal to a target pressure according to a required brake force.

### [Master Cylinder Pressure Control Mechanism]

The structure and operation of the master cylinder pressure control mechanism 5 will now be described. The driving motor 50 is a three-phase DC brushless motor. The driving motor 50 operates by application of an electric current supplied based on a control instruction of the master cylinder pressure control apparatus 8, and generates a desired rotational torque.

The speed-reducing apparatus 51 reduces an output rotation of the driving motor 50 by the pulley speed reducing method. The speed reducing apparatus 51 comprises a small-diameter driving-side pulley 52 disposed at an output shaft of the driving motor 50, a large-diameter driven-side pulley 53 disposed at a ball screw nut 56 of the rotation-linear motion converting apparatus 55, and a belt 54 wound around the driving-side and driven-side pulleys 52 and 53. The speed reducing apparatus 51 amplifies a rotational torque of the driving motor 50 according to a speed reducing ratio (radius ratio of the driving-side and driven-side pulleys 52 and 53), and transmits it to the rotation-linear motion converting apparatus 55.

If a rotational torque of the driving motor 50 is sufficiently large and torque amplification by speed reducing is not necessary, the speed-reducing apparatus 51 may be omitted, and the driving motor 50 and the rotation-linear motion converting apparatus 55 may be directly coupled with each other. In this case, problems related to, for example, reliability, noise preventability, and mountability can be solved which otherwise could occur due to interposition of the speed reducing apparatus 51.

The rotation-linear motion converting apparatus 55 is operable to convert a rotation power of the driving motor 50 into a translational power, and push the primary piston 2b by this translational power. In the first embodiment, a ball screw method is employed as a power converting mechanism, and the rotation-linear converting mechanism 55 comprises the ball screw nut 56, a ball screw shaft 57, a movable member 58, and a return spring 59.

A first housing member HSG1 is coupled to the x axis negative direction side of the master cylinder 2, and a second housing member HSG2 is coupled to the x axis negative direction side of the first housing HSG1. The ball screw nut 56 is disposed in a bearing BRG disposed in the second housing member HSG2, so as to be rotatable around the axis. The driven-side pulley 53 is fitted around the x axis negative direction side of the ball screw nut 56. The hollow ball screw shaft 57 is screwed in the ball screw nut 56. A plurality of balls are disposed in spaces between the ball screw nut 56 and the ball screw shaft 57 so as to be rotationally movable.

The movable member 58 is integrally formed with the ball screw shaft 57 at the end of the x axis positive direction side of the ball screw shaft 57. The primary piston 2b is joined to the surface of the x axis positive direction side of the movable member 58. The primary piston 2b is contained in the first housing member HSG1. The end of the x axis positive direction side of the primary piston 2b protrudes from the first housing member HSG1, and is fitted to the inner circumference of the cylinder 2a of the master cylinder 2.

The return spring 59 is disposed around the primary piston 2b in the first housing member HSG1. While the end of the x axis positive direction side of the return spring 59 is fixed to a surface A of the x axis positive direction side in the first housing member HSG1, the end of the x axis negative direction side of the return spring 59 is engaged with the movable member 58. The return spring 59 is disposed between the surface A and the movable member 28 in a state compressed in the x axis direction, and therefore urges the movable member 58 and the ball screw shaft 57 to the x axis negative direction side.

When the driven-side pulley 53 rotates, the ball screw nut 56 rotates according to the rotation of the driven-side pulley 53. The rotational movement of the ball screw nut 56 causes a linear movement of the ball screw shaft 57 in the x axis direction. Due to a thrust force of the linear movement of the ball screw shaft 57 to the x axis positive direction side, the primary piston 2b is pushed to the x axis positive direction side through the movable member 58. It should be noted that FIG. 1 illustrates the ball screw shaft 57 at an initial position thereof in which the ball screw shaft 57 is located at the most end of the x axis negative direction side, when the brake is not in operation.

On the other hand, an elastic force of the return spring 59 acts on the ball screw shaft 57 in an opposite direction (x axis negative direction) from the thrust force acting in the x axis positive direction. As a result, when the brake is in operation, i.e., when the primary piston 2b is pushed in the x axis positive direction so that the master cylinder pressure Pmc is pressurized, even if the driving motor 50 stops due to a failure and a return control of the ball screw shaft 57 is disabled, the ball screw shaft 57 can be returned to the initial position by the reactive force of the return spring 59. Then, the master cylinder pressure Pmc is reduced to about 0 so that lingering of the brake force can be prevented, and destabilization of the vehicle behavior can be prevented which could otherwise be caused by the lingering of the brake force.

A pair of springs 6d and 6e (urging member) is disposed in an annular space B defined between the input rod 6 and the primary piston 2b. One ends of the pair of springs 6d and 6e are engaged by a flange portion 6c formed at the input rod 6. The other end of the spring 6d is engaged by the partition wall 2h of the primary piston 2b, and the other end of the spring 6e is engaged by the movable member 58. The pair of springs 6d and 6e urge the input rod 6 relative to the primary piston 2b to the neutral position of relative displacement between the primary piston 2b and the input rod 6, and serve to maintain the input rod 6 and the primary piston 2b at the neutral position of the relative displacement when the brake is not in operation. When the relative displacement from the neutral position in either direction occurs between the input rod 6 and the primary piston 2b, an urging force acts to cause the input rod 6 to be moved back to the neutral position relative to the primary piston 2b by the pair of springs 6d and 6e. In an embodiment in which a mechanism for generating an output reactive force is provided at the input rod 6, one of the springs 6d and 6e may be omitted, or both of them may be omitted.

A rotational angle detecting sensor 50a is disposed at the driving motor 50, and a positional signal of the motor output shaft detected by the sensor 50a is input into the master cylinder pressure control apparatus 8. The master cylinder pressure control apparatus 8 calculates a rotational angle of the driving motor 50 based on the input rotational signal, and calculates based on the rotational angle a thrust amount of the rotation-linear motion converting apparatus 25, i.e., a displacement amount of the primary piston 2b along the x axis.

Further, a temperature sensor 50b is disposed at the driving motor 50, and the detected temperature information of the driving motor 50 is input into the master cylinder pressure control apparatus 8.

### (Boosting Control Process)

The master cylinder pressure control mechanism 5 and the master cylinder pressure control apparatus 8 performs a control for boosting a thrust force of the input rod 6, as follows.

The master cylinder pressure control mechanism 5 and the master cylinder pressure control apparatus 8 cause the primary piston 2b to be displaced according to an amount of displacement of the input rod 6 due to a braking operation of a driver. As a result, the primary fluid chamber 2d is pressurized by a thrust force of the primary piston 2b in addition to a thrust force of the input rod 6, whereby the master cylinder pressure Pmc is adjusted. That is, the thrust force of the input rod 6 is boosted. The boosting ratio (hereinafter referred to as “boosting ratio α”) is determined based on the ratio of the cross-sectional areas (hereinafter referred to as “pressure-receiving area AIR” and “pressure-receiving area APP”, respectively) of the input rod 6 and the primary piston 2b perpendicular to the axis of the primary fluid chamber 2d, and other factors in the following way.

Fluid pressure adjustment of the master cylinder pressure Pmc is performed based on the pressure balance relationship expressed by the following equation (1):

Pmc=(FIR+K×Δx)/AIR=(FPP−K×Δx)/APP (1)

in which Pmc represents a fluid pressure in the primary fluid chamber 2d (master cylinder pressure), FIR represents a thrust force of the input rod 6, FPP represents a thrust force of the primary piston 2b, AIR represents the pressure-receiving area of the input rod 6, APP represents the pressure-receiving area of the primary piston 2b, K represents the spring constant of the springs 6d and 6e, and Δx represents a relative displacement amount between the input rod 6 and the primary piston 2b.

In the first embodiment, the master cylinder is configured in such a way that the pressure-receiving area AIR of the input rod 6 is smaller than the pressure-receiving area APP of the primary piston 2b.

The relative displacement amount Δx is expressed by the equation Δx=xPP−xIR, in which xIR represents a displacement of the input rod 6, and xPP represents a displacement of the primary piston 2b. Therefore, Δx is 0 when the input rod 6 and the primary piston 2b are at the neutral position of the relative displacement, Δx is a positive number when the primary piston 2b is displaced forward (displacement to the x axis positive direction side) relative to the input rod 6, and Δx is a negative number when the primary piston 2 is displaced backward relative to the input rod 6. In the above pressure balance equation (1), a sliding resistance of the seal is ignored. The thrust force FPP of the primary piston 2b can be estimated based on an electric current value of the driving motor 50.

On the other hand, the boosting ratio a is expressed by the following equation (2):

α=Pmc×(APP+AIR)/FIR (2)

Therefore, the boosting ratio α is expressed by the following equation (3) by substituting Pmc of the equation (1) into the equation (2):

α=(1+K×Δ×Δx/FIR)×(AIR+APP)/AIR (3)

In the boosting control, the driving motor 50 (the displacement xPP of the primary piston 2b) is controlled so as to obtain target master cylinder pressure characteristics. The master cylinder pressure characteristics mean the characteristics of a change in the master cylinder pressure Pmc relative to the displacement xIR of the input rod 6. Target displacement amount calculation characteristics indicating a change in the relative displacement Δx relative to the displacement xIR of the input rod 6 can be obtained according to stroke characteristics indicating the displacement xPP of the primary piston 2b relative to the displacement xIR of the input rod 6, and the above-mentioned target master cylinder pressure characteristics. A target value (hereinafter referred to as “target displacement amount Δx*”) of the relative displacement amount Δx is calculated based on the data of the target displacement amount calculation characteristics obtained by a detection operation.

That is, the target displacement amount calculation characteristics indicates the characteristics of a change in the target displacement amount Δx* relative to the displacement xIR of the input rod 6, and one target displacement amount Δx* is determined for one displacement amount xIR of the input rod 6. The master cylinder pressure Pmc corresponding to the target displacement amount Δx* is generated in the master cylinder 2 by controlling a rotation of the driving motor 50 (the displacement amount xPP of the primary piston 2b) so as to realize the target displacement amount Δx* determined according to the detected displacement amount xIR of the input rod 6.

In this way, the displacement amount xIR of the input rod 6 is detected by the brake operation amount detecting apparatus 7, the displacement amount xPP of the primary piston 2b is calculated based on a signal from the rotational angle detecting sensor 50a, and the relative displacement amount Δx is calculated by subtraction between these detected (calculated) displacement amounts. In particular, in the boosting control, the target displacement amount Δx* is set based on the detected displacement amount xIR and the target displacement amount calculation characteristics, and the driving motor 50 is controlled (feedback control) such that the detected (calculated) relative displacement amount Δx becomes equal to the target displacement amount Δx*. In some embodiments, a stroke sensor for detecting the displacement amount xPP of the primary piston 2b may be additionally disposed.

In the present embodiment, the boosting control can be performed without use of a pressing force sensor, so that cost can be reduced by an amount corresponding to this omission. In addition, a larger boosting ration or a smaller boosting ratio than the boosting ratio determined based on the pressure-receiving area ratio (AIR+APP)/AIR can be obtained by controlling the driving motor 50 such that the relative displacement amount Δx becomes equal to an arbitrary predetermined value. Therefore, a braking force based on a desired boosting ratio can be obtained.

An invariable boosting control is a control method of controlling the driving motor 50 such that the input rod 6 and the primary piston 2b are integrally displaced, i.e., such that the primary piston 2b is constantly displaced to the above-mentioned neutral position relative to the input rod 6 so that the relative displacement amount Δx is constantly 0. If the primary piston 2b is displaced so that Δx becomes equal to 0 in this way, the boosting ratio α is determined as a fixed value, α=(AIR+APP)/AIR by the equation (3). Therefore, the invariable (required) boosting ratio can be obtained by setting AIR and APP based on the required boosting ratio, and controlling the primary piston 2b such that the displacement amount xPP becomes equal to the displacement amount xIR of the input rod 6.

In the target master cylinder pressure characteristics in the invariable boosting control, the master cylinder pressure Pmc generated according to a forward movement of the input rod 6 (displacement to the x axis positive direction side) increases in the form of a quadric curve, a cubic curve, or a multi-order curve formed by combining the curves with a curve of a higher order (hereinafter, they are collectively referred to as “multi-order curve”). In addition, the invariable boosting control has stroke characteristics in which the primary piston 2b is displaced by a same amount as the displacement xIR of the input rod 6 (xPP=xIR). In the target displacement amount calculation characteristics obtained based on the stroke characteristic and the above-mentioned target master cylinder pressure characteristics, the target displacement amount Δx* is always 0 for any displacement xIR of the input rod 6

On the other hand, a variable boosting control is a control method of controlling the driving motor 50 such that the target displacement amount Δx* is set to a predetermined positive value, and the relative displacement amount Δx becomes equal to this predetermined value. As a result, as the input rod 6 moves forward in the direction causing the master cylinder pressure Pmc to increase, the primary piston 2b is controlled such that the displacement amount xPP of the primary piston 2b becomes larger than the displacement amount xIR of the piston rod 6. The boosting ratio α shows an increase of (1+K×Δx/FIR)-fold, according to the above-mentioned equation (3). This is the same as displacing the primary piston 2b by an amount corresponding to the product obtained by multiplying the displacement amount xIR of the input rod 6 by the proportional gain (1+K×Δx/FIR). In this way, the boosting ratio α is variable according to Δx. The master cylinder pressure control mechanism 5 serves as a boosting source, and a braking force as requested by a driver can be generated with a largely reduced pedal pressing force.

That is, although it is desirable in terms of controllability to have the value 1 as the above-mentioned proportional gain (1+K×Δx/FIR), the proportional gain can be temporarily changed to a value greater than 1 when a braking force stronger than an amount of a brake operation of a driver is required due to, for example, emergency braking. As a result, the master cylinder pressure Pmc can be increased compared to that at a normal occasion (at the time that the above-mentioned proportional gain is 1) with the same brake operation amount, and a greater braking force can be generated. Whether emergency braking should be performed is determined, for example, by determining whether a time rate of change of a signal from the brake operation amount detecting apparatus 7 is larger than a predetermined value.

In this way, the variable boosting control is a method of controlling the driving motor 50 such that the primary piston 2b is moved further forward than a forward movement of the input rod 6, and the relative displacement amount Δx of the primary piston 2b relative to the input rod 6 becomes larger as the input rod 6 moves forward, whereby an increase in the master cylinder Pmc due to the forward movement of the input rod 6 is greater than that when the invariable boosting force control is performed.

In the target master cylinder pressure characteristics in the variable boosting control, an increase in the master cylinder pressure Pme caused by a forward movement of the input rod 6 (displacement to the x axis positive direction side) is greater than that in the invariable boosting force control (the master cylinder pressure characteristics increasing in the form of the multi-order curve is more precipitous). In addition, the variable boosting control has stroke characteristics in which an increase in the displacement xPP of the primary piston 2b when the displacement xIR of the input rod 6 increases is 1 or more. In the target displacement amount calculation characteristics obtained based on the stroke characteristics and the target master cylinder pressure characteristics, the target displacement amount Δx* increases at a predetermined ratio as the displacement xIR of the input rod 6 increases.

The variable boosting control may include, in addition to the above-mentioned controlling manner [controlling the driving motor 50 such that the displacement amount xPP of the primary piston 2b becomes greater than the displacement amount xIR of the input rod 6 as the input rod 6 moves in the direction causing the master cylinder pressure Pmc to increase], controlling the driving motor 50 such that the displacement amount xPP of the primary piston 2b becomes less than the displacement amount xIR of the input rod 6 as the input rod 6 moves in the direction causing the master cylinder pressure Pme to increase. By changing the proportional gain to a value less than 1 in this way, the present invention may be utilized for the regenerative braking control in which a fluid pressure brake is depressurized according to a regenerative braking force of a hybrid vehicle.

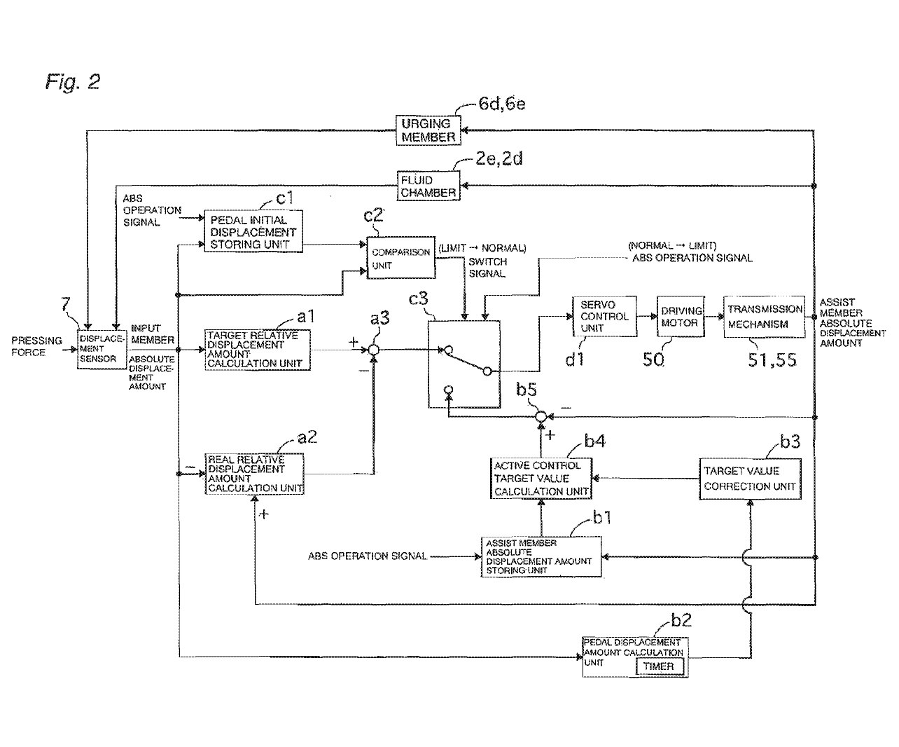

FIG. 2 is a block diagram illustrating a control configuration of the first embodiment of the present invention. The configuration of a normal boosting control (assist member passive control) that is a basic control will firstly be described, and the configuration of an assist member active control for limiting an operation range of the assist member during an operation of the ABS control will be described after that.

In the following description, the rotation-linear motion converting mechanism 55 and the speed reducing mechanism 51 are collectively referred to as “transmission mechanism”, and the members (the ball screw shaft 57, the movable member 58 and the primary piston 2b) moving forward and backward by a rotation of the driving motor 50 through the transmission mechanism are collectively referred to as “assist member”. A displacement amount of the assist member are calculated based on an output from the rotational angle detecting sensor 50a of the driving motor 50, and hereinafter, this displacement amount is referred to as “assist member absolute displacement amount”.

The displacement sensors 7a and 7b serving as the brake operation amount detecting apparatus 7 are collectively referred to as “displacement sensor 7”, and the input rod 6 moving forward and backward according to a movement of the brake pedal BP is referred to as “input member”. The displacement sensor 7 detects an amount of displacement of the input member along the x axis, and hereinafter, this displacement amount is referred to as “input member absolute displacement amount”.

### [Assist Member Passive Control]

At a target relative displacement amount calculation unit a1, the target relative displacement amount is calculated based on the input member absolute displacement amount. There are several methods for setting the target relative displacement amount, such as the method of setting it based on the relationship between the set boosting ratio and the input member absolute displacement amount, the method of setting it based on whether emergent braking is required in, for example, another controller, and the method of setting it based on whether regenerative braking is required in a hybrid vehicle. The details thereof will be described later. All that is important now is that the target relative displacement amount is set in the assist member passive control.

At a real relative displacement amount calculation unit a2, a real relative displacement amount is calculated based on the deviation between the input member absolute displacement amount detected by the displacement sensor 7, and the assist member absolute displacement amount detected by the rotational angle detecting sensor 50a.

At a passive control deviation calculation unit a3, the deviation between the target relative displacement amount and the real relative displacement amount is calculated. The deviation calculated here is output to a switch unit c3 which will be described later. When the assist member passive control is selected at the switch unit c3, the following procedure is performed.

At a servo control unit dl, a servo control is performed by feedback based on the deviation calculated at the passive control deviation calculation unit a3. An electric current instruction value to be supplied into the driving motor 50 is calculated, and the electric current instruction value is output into the driving motor 50. The electric current output into the driving motor 50 causes the driving motor 50 to rotate, and the generated rotational power is converted into a translational power through the transmission mechanism, which causes the assist member to move forward and backward. The servo control is, for example, a control having a control amount calculated based on the following equation; electric current instruction value=Kp×(Deviation)+Ki ∫ (Deviation) dt+Kd×d (Deviation)/dt, in which Kp represents the proportional gain, Ki represents the integral gain, and Kd represents the differential gain. The servo control is not limited to this equation, and may be configured by combining two of the proportional component, the integral component, and the differential component as necessary.

### [Assist Member Active Control]

At an assist member absolute displacement amount storing unit b1, the assist member absolute displacement amount and an ABS operation signal from the wheel cylinder pressure control apparatus 9 are received as input, and the assist member absolute displacement amount at the time of input of the ABS operation signal is stored.

At a pedal displacement amount calculation unit b2, a displacement amount of the input member absolute displacement amount is updated and stored each time the timer count reaches a predetermined timer value.

At a target value correction unit b3, the target value set in the assist member active control is corrected according to the pedal displacement amount calculated at the pedal displacement amount calculation unit b2.

At an active control target value calculation unit b4, the absolute position stored at the assist member absolute displacement amount storing unit b1 is received as an initial target value of the assist member, and the value corrected based on the instruction from the target value correction unit b3 is output as a final active control target value of the assist member.

At an active control deviation calculation unit b5, a deviation between the active control target value set at the active control target value calculating unit b4, and the assist member absolute displacement amount is calculated. The deviation calculated here is output into the switch unit c3 which will be described later. When the assist member active control is selected at the switch unit c3, the following procedure is performed.

At the servo control unit dl, the servo control is performed by feedback based on the deviation calculated at the active control deviation calculation unit b5, and an electric current instruction value to be supplied into the driving motor 50 is calculated, and is output into the driving motor 50. The electric current output into the driving motor 50 causes the driving motor 50 to rotate, and the generated rotational power is converted into a translational power through the transmission mechanism, which causes the assist member to move forward and backward. In the assist member active control, the control gains Kp, Ki and Kd may be set in a different manner from that in the assist member passive control, and no limitation is applied to them.

### [Control Switch Process]

The switching process for switch between the assist member passive control and the assist member active control will now be described. At a pedal initial displacement storing unit c1, the input member absolute displacement amount and the ABS operation signal from the wheel cylinder pressure control apparatus 9 are received as input, and a value resulting from subtraction of a predetermined offset value from the input member absolute displacement amount at the time of the input of the ABS operation signal is stored.

At a comparison unit c2, the current input member absolute displacement amount is compared with the value resulting from subtraction of the predetermined offset value from the stored pedal initial displacement, and if the brake pedal BP is returned by a driver, an instruction for switch from the assist member active control to the assist member passive control is output.

At the switch unit c3, the control mode is switched based on the ABS operation signal and a switch signal from the comparison unit c2. If the ABS operating signal is input, the control mode is switched from the assist member passive control to the assist member active control. If an instruction signal is input from the comparison unit c2, then the control mode is switched from the assist member active control to the assist member passive control.

### [Reason and Mechanism of Assist Member Active Control]

The relationship between driver's pressing force input into the displacement sensor 7, and the fluid chambers 2e and 2d and the urging members 6d and 6e will now be described. In the control configuration of the first embodiment, when the assist member is actuated by the driving motor 50, the influence is exerted on the fluid chambers 2e and 2d, in addition to the input member through the urging members. Since the input member is disposed so as to face the fluid chambers 2e and 2d, and is elastically coupled with the assist member through the urging members, the influence exerted on the fluid chambers 2e and 2d is also exerted on the input member through a change in the fluid pressure. In addition, since the input member is displaced by an input of a pressing force of a driver, the value detected by the displacement sensor 7 shows both of the influence based on the pressing force of the driver, and the influence based on the assist member actuation.

As mentioned above, in the assist member passive control which is a normal control, the displacement of the input member caused by a pressing force of a driver is detected, and the assist member is controlled according to the displacement of the input member. At this time, the control gain is set so as not to cause vibration of the control system in order to achieve stabilization of the control system.

When the ABS control is performed in the wheel cylinder pressure control apparatus 9, the brake fluid discharged from the wheel cylinder by depressurization back-flows to the master cylinder side, and the influence thereof is exerted on the fluid chambers 2e and 2d. Then, the influence is also exerted on the displacement sensor 7, bringing about an effect that is different from the effect originally expected in the assist member passive control, whereby disturbance may occur in the control system.

Since it is expected that the depressurization operation is performed intermittently and is repeated per extremely short cycle, the influence by the back-flow of the brake fluid to the master cylinder side may cause fluctuation of an input signal and thereby cause vibration of the whole control system. Due to this vibration, the input member may be largely displaced forward and backward, whereby a driver may have a strange or discomfort feeling.

Therefore, in the first embodiment, when the ABS control operation is detected, the control mode is switched from the assist member passive control performed based on a detection value of the displacement sensor 7 to the assist member active control. The active control target value is set so as to reduce the influence of disturbance that would be directly exerted on the fluid chambers 2e and 2d in the assist member passive control performed based on a detection value of the displacement sensor 7, and a feedback control is performed.

In particular, a feedback loop is formed in which the assist member absolute displacement amount at the time of start of the ABS control is set as a target value. Since the displacement of the assist member is limited, the influence of the back-flow of the brake fluid to the master cylinder side is exerted on the input member. However, since the pair of springs 6d and 6e (urging member) is disposed between the assist member and the input member so as to serve to maintain the assist member and the input member at the neutral position of the relative displacement between the assist member and the input member, even if a large master cylinder pressure acts on the input member, a reactive force by the urging members prevents the input member from being significantly displaced. Therefore, it is possible to prevent that a driver would have a strange or discomfort feeling. In addition, since slight vibration occurs, a driver can sense that the ABS control operation is being performed.

Further, as mentioned above, according to the assist member active control, although the absolute displacement amount of the input member is slightly changed, no influence is exerted on the control system due to the change in the absolute displacement amount of the input member since the absolute displacement amount of the input member is not used as an input signal in the assist member active control.

However, not using the absolute displacement amount of the input member as input information means that no information based on a brake pedal operation is used in the assist member active control. As a result, it is impossible to accept displacement of the input member according to a brake pedal operation of a driver, and the input member is not returned when the driver returns the brake pedal during the ABS control. For solving this problem, the detection value of the displacement sensor 7 is updated based on the predetermined timer value, i.e., the phase of a signal of the displacement sensor 7 is delayed to be detected, and correction of the active control target value, and switch from the assist member active control to the assist member passive control are performed according to a change amount of a detection value of the displacement sensor 7.

Now, a control process according to the above-mentioned control configuration of the first embodiment will be described with reference to a flow chart for better understanding.

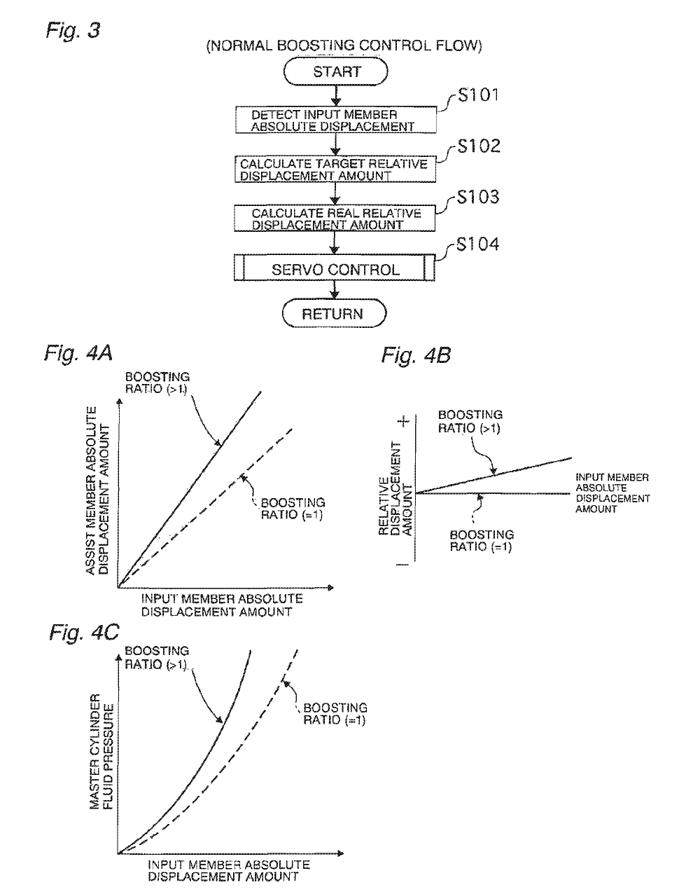

FIG. 3 is a flow chart illustrating a basic control configuration of the assist member passive control. At step S101, the input member absolute displacement amount is detected. At step S102, the target relative displacement amount is calculated. At step S103, the real relative displacement amount is calculated. At step S104, the servo control is performed based on the passive control deviation between the target relative displacement amount and the real relative displacement amount.

FIG. 4A is a graph showing the relationship between the input member absolute displacement amount and the assist member absolute displacement amount regarding the boosting ratio. FIG. 4B is a graph showing the relationship between the input member absolute displacement amount and the relative displacement amount regarding the boosting ratio. FIG. 4C is a graph showing the relationship between the input member absolute displacement amount and the master cylinder fluid pressure regarding the boosting ratio. For example, when the boosting ratio is set to a value larger than 1, the assist member absolute displacement amount relative to the input member absolute displacement amount is larger than that when the boosting ration is 1. In other words, the target relative displacement amount becomes larger as the input member absolute displacement amount gets larger (the target relative displacement amount is 0 when the boosting ratio is 1). Since the details of the principle is described above, it is not repeated here.

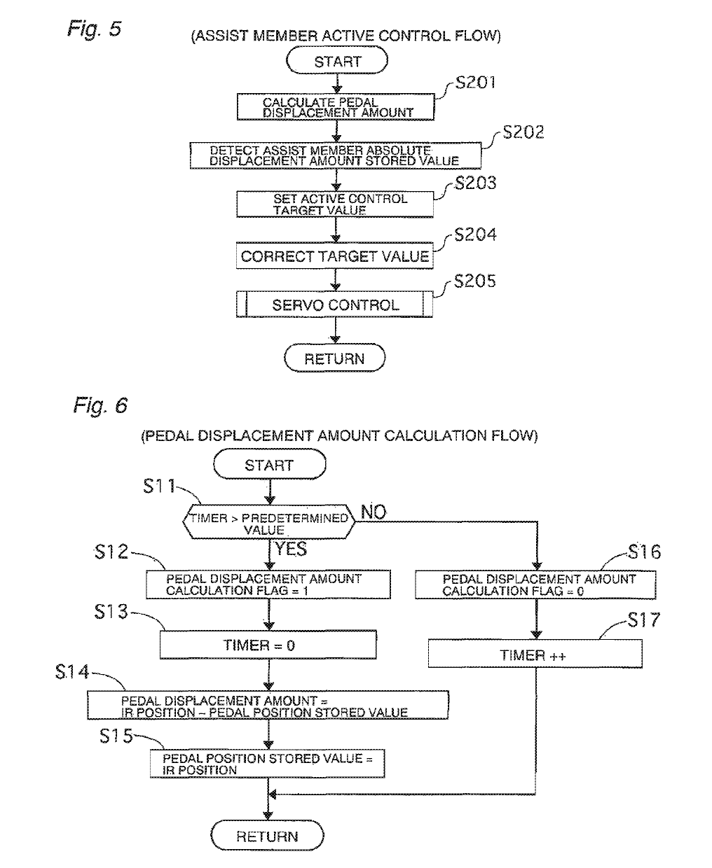

FIG. 5 is a flow chart illustrating a basic control configuration of the assist member active control. At step S201, the pedal displacement amount is calculated. At step S202, the assist member absolute displacement amount at the time of start of the ABS control is stored. At step S203, the stored assist member absolute position is set as the active control target value. At step S204, the active control target value is corrected based on the pedal displacement amount. At step S205, the servo control is performed such that the assist member absolute displacement amount becomes equal to the set active control target value.

FIG. 6 is a flow chart illustrating the pedal displacement amount calculating process performed at step S201 shown in FIG. 5. At step S11, it is determined whether the timer, in which count-up is started upon receiving the ABS operation signal, shows a larger value than a predetermined value. If the timer shows a larger value than the predetermined value, then it is determined that update should be performed now and the flow proceeds to S12; if not, the flow proceeds to step S16.

The predetermined value should be larger than a cycle of application of disturbance to the master cylinder side due to the ABS control, and be a value for making it possible to detect a condition of driver's brake pedal operation with sufficiently excellent responsiveness. With such a value set as the predetermined value, it is possible to restrain vibration of the control system and at the same time, securely obtain excellent responsiveness. At step S12, a pedal displacement amount calculation flag is set to 1. At step S13, the timer is reset. At step S14, the difference between the current input member absolute displacement amount and a pedal position stored value is calculated as the pedal displacement amount. At step S15, the pedal position stored value is updated and the current input member absolute displacement amount is stored as the pedal position stored value. At step S16, the pedal change amount calculation flag is reset to 0. At step S17, the timer is counted up.

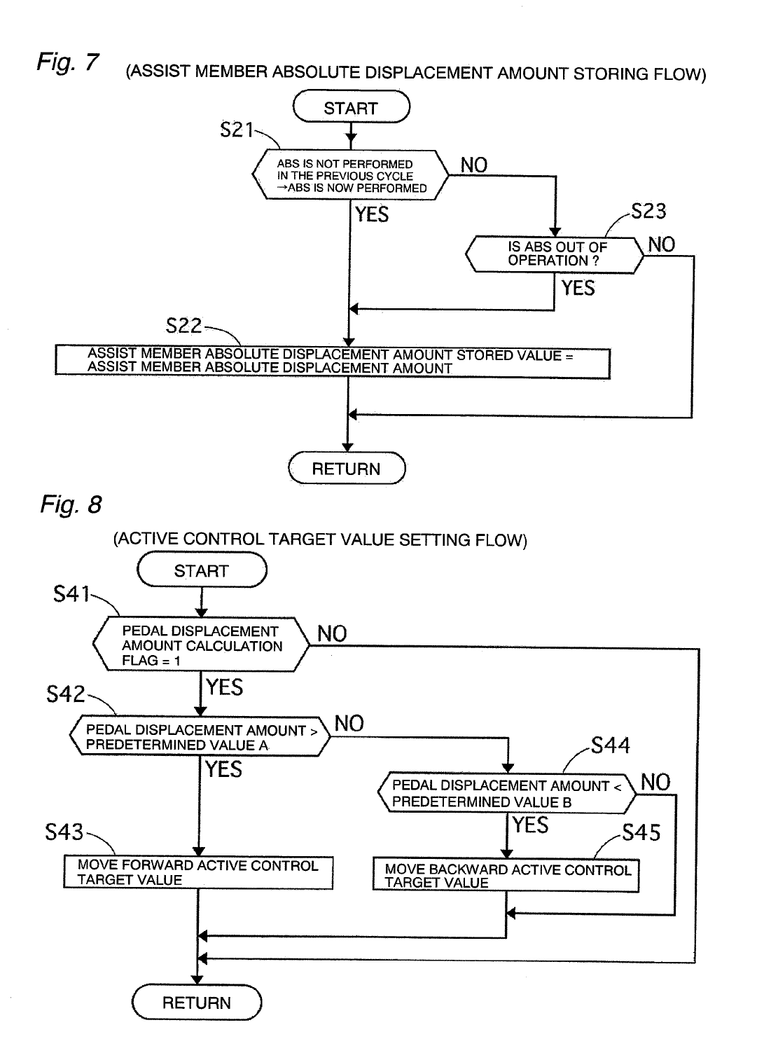

FIG. 7 is a flow chart illustrating the assist member absolute displacement amount storing process performed at step S202 shown in FIG. 5. At step S21, it is determined whether the condition is changed from the condition in which the ABS control is not performed in the previous control cycle, to the condition in which the ABS control is performed in the current control cycle. If the condition is changed, then the flow proceeds to step S22; if not, the flow proceeds to step S23. At step S22, the current assist member absolute displacement amount is stored as an assist member absolute displacement amount stored value. At step S23, it is determined whether the ABS control is out of operation. If the ABS control is out of operation, then the flow proceeds to step S22, and the current assist member absolute displacement amount is stored as the stored value; if the ABS control is performed, then update of the stored value is prohibited. Then, the current control flow is ended.

FIG. 8 is a flow chart illustrating an active control target value setting process performed at steps S203 and S204 shown in FIG. 5. At step S41, it is determined whether the pedal displacement amount calculation flag, which is set in the flow chart shown in FIG. 6, is 1. If the flag is 1, then it is determined that the pedal displacement amount is updated, and the flow proceeds to step S42; if the flag is 0, then it is determined that update of the pedal displacement amount is prohibited, and the current control flow is ended.

At step S42, it is determined whether the updated pedal displacement amount is larger than a predetermined value A. If the updated pedal change amount is larger than the value A, then the flow proceeds to step S43; if not, the flow proceeds to step s44. The predetermined value A should be within a range for making it possible to detect a condition of driver's brake pedal operation with sufficiently excellent responsiveness, and preventing vibration of the control system.

At step S43, it is determined that the brake pedal is pressed down by the driver, and the active control target value is obtained by correcting the assist member absolute displacement amount stored at the time of start of the ABS control (or the corrected active control target value) to a value causing the assist member to be displaced further forward.

At step S44, it is determined whether the pedal displacement amount is less than a predetermined value B. If the pedal displacement amount is less than the value B, then the flow proceeds to step S45; if not, it is determined that a pedal operation is not performed and the current control flow is ended. The predetermined value B should be within a range for making it possible to detect a condition of driver's brake pedal operation with sufficiently excellent responsiveness, and preventing vibration of the control system.

At step S45, it is determined that the brake pedal is returned by the driver, and the active control target value is obtained by correcting the assist member absolute displacement amount stored at the time of start of the ABS control (or the corrected active control target value) to a value causing the assist member to be displaced backward.

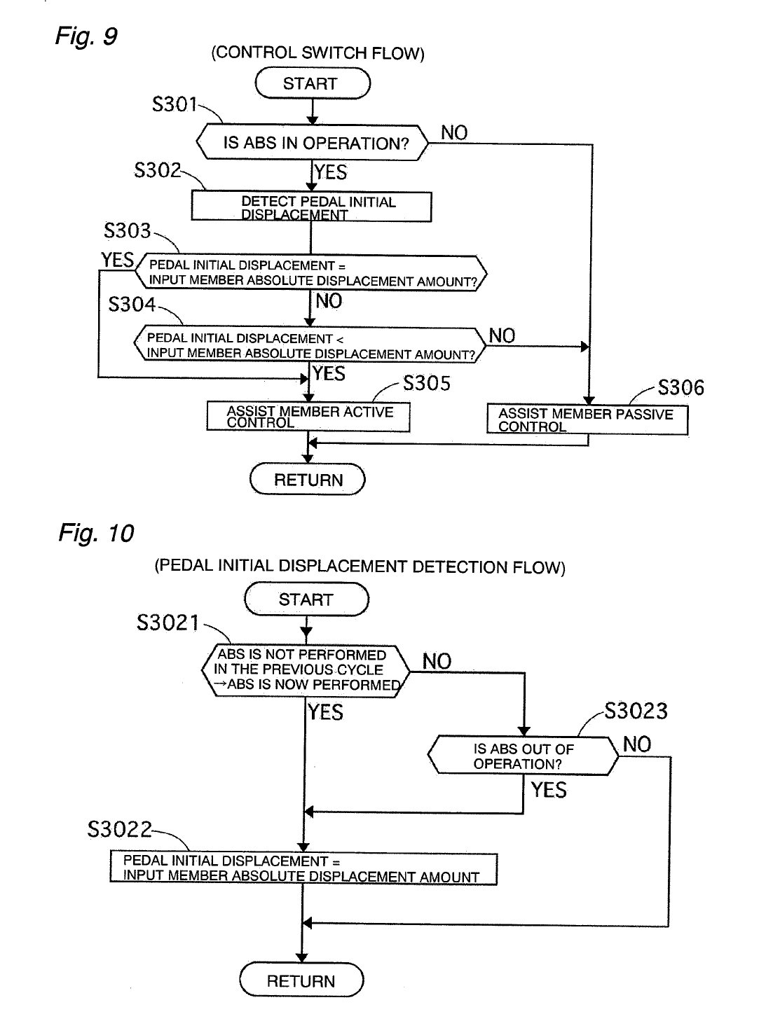

FIG. 9 is a flow chart illustrating the control switch process performed at the pedal initial displacement storing unit c1, the comparison unit c2, and the switch unit c3.

At step S301, it is determined based on a signal from the wheel cylinder pressure control apparatus 9 whether the ABS control is performed. If the ABS control is performed, then the flow proceeds to step S302; if the ABS control is not performed, then the flow proceeds to step S306, and the assist member passive control, which is a normal boosting control, is performed. At step S302, the value resulting from subtraction of the predetermined offset value from the input member absolute displacement amount at the time of input of the ABS operation signal is stored as the pedal initial displacement.

At step S303, it is determined whether the input member absolute displacement amount is equal to the pedal initial displacement. If the input member absolute displacement amount is equal to the pedal initial displacement, then the flow proceeds to step S305, and the assist member active control is performed; if not, the flow proceeds to step S304.

At step S304, it is determined whether the current input member absolute displacement amount is larger than the pedal initial displacement. If the current input member absolute displacement amount is larger than the pedal initial displacement, then the flow proceeds to step S305, and the assist member active control is performed; if not, it is determined that the brake pedal is returned by the driver, and the flow proceeds step S306. At step S306, the assist member passive control is performed.

FIG. 10 is a flow chart illustrating the pedal initial displacement detecting process. At step S3021, it is determined whether the condition is changed such that the ABS control is not performed in the previous control cycle, and then the ABS control is performed in the current control cycle. If the condition is changed, then the flow proceeds to step S3022; if not, then the flow proceeds to step S3023. At step S3022, the current input member absolute displacement amount is stored as the pedal initial displacement. At step S3023, it is determined whether the ABS control is out of operation. If the ABS control is out of operation, then the flow proceeds to step S3022, and the pedal initial displacement is updated. If the ABS control is performed, then the current control flow is ended without updating the pedal initial displacement. That is, the pedal initial displacement that is set at the time of start of the ABS control is not updated during the ABS control.

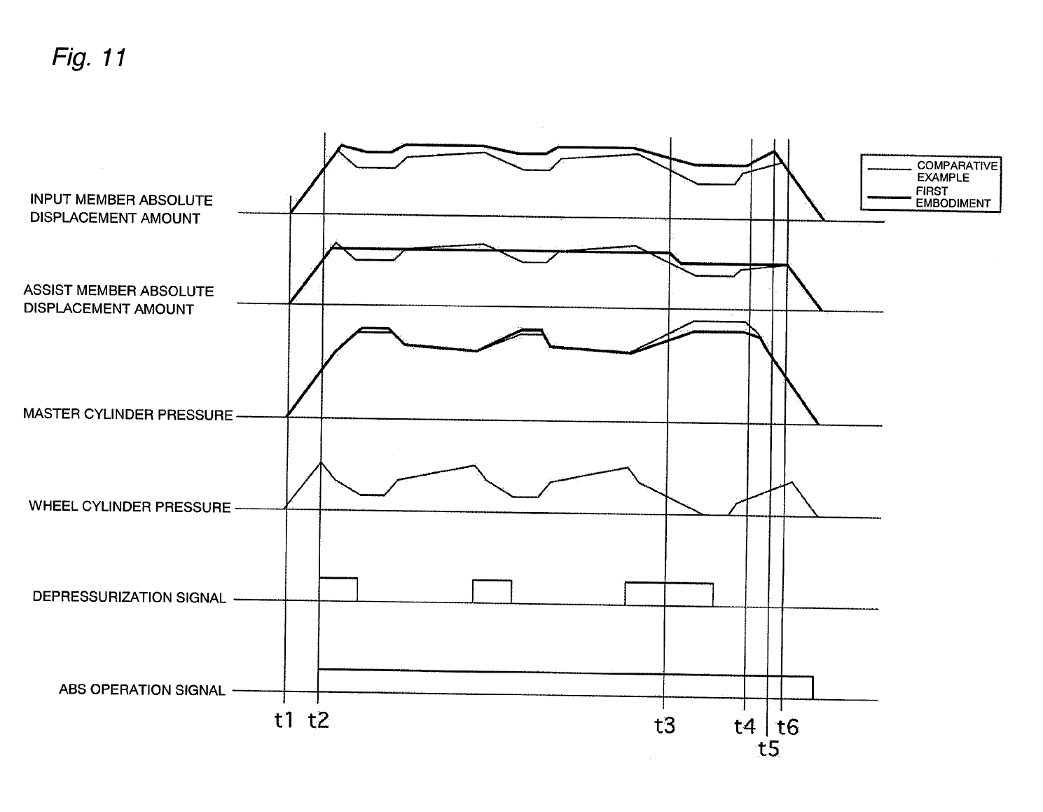

The operation according to the above-mentioned control flow will now be described. FIG. 11 is a time chart illustrating the assist member active control during the ABS control in the first embodiment. In FIG. 11, the bold solid line indicates an operation in the first embodiment, and the thin solid line indicates an operation in a comparative example in which the control switch is not performed.

At time t1, the assist member passive control remains selected. Therefore, when the driver starts to press down the brake pedal BP, the input member starts a stroke, and the assist member is displaced accordingly. In addition, the master cylinder pressure is generated according to the currently selected boosting ratio, and the wheel cylinder pressure starts to increase accordingly.

At time t2, since a slip rate of the wheel becomes larger than a predetermined value and therefore the ABS control is started, a depressurization signal is output in the wheel cylinder pressure control mechanism 3, and the brake fluid is discharged from the wheel cylinder to the reservoir. At the same time, the discharged brake fluid back-flows to the master cylinder side by operation the pumps P1 and P2. On the other hand, in the master cylinder pressure control mechanism 5, the control mode is changed from the assist member passive control to the assist member active control upon receiving an input of the ABS operation signal, and the assist member absolute displacement amount at the time of input of the ABS operation signal is stored as the active control target value.

Simultaneously, the value resulting from subtraction of the predetermined offset value from the input member absolute displacement amount at the time of start of the ABS control is stored as the pedal initial position, and count-up of the timer for calculating the pedal displacement amount is started.

While the ABS control operation continues, basically, the assist member absolute displacement amount is kept at the active control target value. At this time, although the master cylinder pressure increases according to the amount of the brake fluid back-flowing due to the ABS control operation, the assist member absolute displacement amount is not changed according to the change in the master cylinder pressure since the assist member is controlled such that the absolute displacement amount thereof is not changed. However, the change in the master cylinder pressure affects the input member coupled to the assist member through the urging members, whereby the absolute displacement amount thereof is slightly changed while the urging member limit the change.

After that, this control condition continues, and the brake fluid back-flows to the master cylinder side each time a depressurizing control for the ABS control operation is performed, and the master cylinder pressure is generated accordingly.

That is, in the comparative example, a change in the master cylinder pressure due to the back-flowing brake fluid causes the input member absolute displacement amount to be changed, and therefore the assist member absolute displacement amount to be also changed accordingly. After that, repeat of this change results in vibration of the control system and a significant change in the input member absolute displacement amount, giving a strange and discomfort feeling to the driver. On the other hand, in the first embodiment, it is possible to restrain vibration of the control system and reduce a change in the input member absolute displacement amount by switching the control mode to the assist member active control so as to limit a change in the assist member absolute displacement amount.

At time t3, when the driver slightly returns the brake pedal, it is determined that the pedal displacement amount from the stored pedal initial position is less than the predetermined value B. Then, the active control target value is changed to a smaller value as the assist member absolute displacement amount, i.e., the active control target value is changed to a value causing the brake pedal BP to be displaced backward, whereby the assist member absolute displacement amount is changed.

At time t4, when the driver starts to press down the brake pedal BP, the input member absolute displacement amount increases. At this time, although the input member absolute displacement amount is largely changed, because count-up of the timer is not finished, the pedal displacement amount is not updated, and therefore the active control target value is not changed, whereby the assist member absolute displacement amount remains the same.

At time t5, when the driver starts to return the brake pedal BP, the master cylinder pressure also starts to decrease accordingly. At time t6, once the input member absolute displacement amount becomes less than the pedal initial displacement, the control mode is switched from the assist member active control to the assist member passive control, so that the assist member is controlled so as to achieve a relative displacement amount according to the input member absolute displacement amount.

Here are advantageous effects brought about by the creation of the technical idea according to the first embodiment.

The first embodiment comprises the input member movable forward and backward according to an operation of the brake pedal, the assist member disposed so as to be movable relative to the input member in the moving direction of the input member, the urging member operable to urge the input member relative to the assist member toward the neutral position of the relative displacement between the assist member and the input member, the actuator (driving motor 50) operable to cause the assist member to move forward and backward, the control unit (master cylinder pressure control apparatus 8) operable to control the driving motor 50, the booster (master cylinder pressure control apparatus 5) operable to generate a pressurized brake fluid pressure in the master cylinder with use of a thrust force generated by a movement of the assist member, and the fluid pressure control unit (wheel cylinder pressure control mechanism 3 and the wheel cylinder pressure control apparatus 9) disposed between the master cylinder 2 and the wheel cylinder 4. The fluid pressure control unit is operable to discharge brake fluid in the wheel cylinder 4 when a slip condition of the wheel is detected, and cause the discharged brake fluid to back-flow to the master cylinder 2. The master cylinder pressure control apparatus 8 performs the assist member passive control and the assist member active control. In the assist member passive control, the driving motor 50 is controlled such that the assist member is displaced forward and backward according to a displacement amount of the input member. In the assist member active control, while the fluid pressure control unit (wheel cylinder pressure control mechanism 3 and the wheel cylinder pressure control apparatus 9) is operating, the displacement of the input member due to an input of a force from the assist member is limited.

According to the first embodiment, even when the brake fluid back-flows to the master cylinder side due to an operation of the fluid pressure control unit and the back-flowing brake fluid affects the assist member, the displacement of the input member transmitted from the assist member through the urging member is limited, whereby pulsation and pedal vibration can be restrained and an excellent pedal feeling can be provided.

In the assist member active control, the displacement amount of the assist member is limited within the predetermined range. Therefore, the movement of the assist member can be limited within the predetermined range, whereby the movement of the input member coupled to the assist member through the urging member can be limited.

The input member and the assist member are disposed so as to face the first chamber (primary fluid chamber 2d) on which the master cylinder pressure acts, and the pressure-receiving area of the input member is smaller than that of the assist member. Therefore, even when the master cylinder pressure is changed, a force acting on the input member can be reduced, whereby the movement of the input member can be reduced.

In the assist member active control, the displacement amount of the assist member is zero. In particular, the target value is set to the assist member absolute displacement amount at the time of start of the ABS control operation, and the assist member is controlled so as to achieve this target value. Therefore, the movement of the input member can be further limited.

The control unit (master cylinder pressure control apparatus 8) and the fluid pressure control unit (wheel cylinder pressure control apparatus 9) are connected with each other through the communication line L. Therefore, they can exchange various information.

The control unit (master cylinder pressure control apparatus 8) receives a operating condition of the fluid pressure control unit (wheel cylinder pressure control mechanism 3 and wheel cylinder pressure control apparatus 9) from the fluid pressure control unit (wheel cylinder pressure control apparatus 9) through the communication line L, thereby capable of quickly detecting the information of the fluid pressure control unit.

The control unit (master cylinder pressure control apparatus 8) performs the assist member active control when it receives an operating condition of the fluid pressure control unit (wheel cylinder pressure control mechanism 3 and wheel cylinder pressure control apparatus 9). Therefore, the control unit can start the assist member active control in advance as early as some influence is expected to affect the master cylinder side, whereby the pedal feeling can be further improved.

The operation of the fluid pressure control unit (wheel cylinder pressure control mechanism 3 and wheel cylinder pressure control apparatus 9) is the operation of the anti-lock brake control (ABS control operation). The control unit (master cylinder pressure control apparatus 8) includes the position storing unit (assist member absolute displacement amount storing unit b1) for storing the assist member absolute displacement amount that is the absolute position of the assist member at the time of start of the anti-lock brake control. In the assist member active control, the position of the assist member is controlled so as to be within the predetermined range relative to the stored position.

Therefore, even though the master cylinder pressure is changed due to the ABS control operation and the input member is displaced, the assist member is controlled to be positioned at the stored position without using the information of the input member, whereby vibration of the control system can be restrained, and an excellent pedal feeling can be provided.

The first embodiment of the present invention comprises the assist member disposed so as to be movable relative to the input member movable forward and backward according to an operation of the brake pedal BP, the urging member operable to urge the input member relative to the assist member toward the neutral position of the relative displacement between the assist member and the input member, the booster (master cylinder pressure control apparatus 5) operable to pressurize the inside of the master cylinder by displacing the assist member, the control unit (master cylinder pressure control apparatus 8) operable to control the actuator (driving motor 50) operable to drive the assist member according to the predetermined input signal, and the fluid pressure control unit (wheel cylinder pressure control mechanism 3 and the wheel cylinder pressure control apparatus 9) disposed between the master cylinder 2 and the wheel cylinder 4. The control unit (master cylinder pressure control apparatus 8) switches the predetermined input signal for driving the actuator according to an operation condition of the fluid pressure control unit (wheel cylinder pressure control mechanism 3 and the wheel cylinder pressure control apparatus 9).

As a result, stabilization of the control system can be achieved by switching the input signal when destabilization of the control system is expected from an operation condition of the fluid pressure control unit.

As the predetermined input signal, a stroke amount of the input member (input member absolute displacement amount) is used when the fluid pressure control unit is not in operation, and a signal according to an absolute position of the assist member (assist member absolute displacement amount) is used when the fluid pressure control unit is in operation. That is, when the fluid pressure control unit is not in operation, the assist member is controlled with use of the input member absolute displacement amount so that an intention of a driver is maximally reflected. When the fluid pressure control unit is in operation, in consideration of influence to be exerted on the control system by displacement of the input member caused by the operation of the fluid pressure control unit, a signal according to the absolute displacement amount of the assist member which has less phase delay, i.e., which is directly controlled is used as the predetermined input signal, whereby a stable pedal feeling can be provided.

The first embodiment of the present invention comprises the assist member disposed so as to be movable relative to the input member movable forward and backward according to an operation of the brake pedal BP, the urging member operable to urge the input member relative to the assist member toward the neutral position of the relative displacement between the assist member and the input member, the booster (master cylinder pressure control mechanism 5) operable to pressurize the inside of the master cylinder by displacing the assist member, the control unit (master cylinder pressure control apparatus 8) operable to control the actuator (driving motor 50) operable to drive the assist member according to the input signal, and the fluid pressure control unit (wheel cylinder pressure control mechanism 3 and the wheel cylinder pressure control apparatus 9) disposed between the master cylinder 2 and the wheel cylinder 4. The control unit (master cylinder pressure control apparatus 8) may switch the control gain for driving the actuator (driving motor 50) according to an operation condition of the fluid pressure control unit (wheel cylinder pressure control mechanism 3 and the wheel cylinder pressure control apparatus 9).

That is, vibration of the control system may occur due to a change in the detection value of the displacement sensor 7 if the assist member passive control using a detection value of the displacement sensor 7 is performed when the ABS control is performed. In the first embodiment of the present invention, for prevention of such vibration of the control system, the assist member active control is performed by using the assist member absolute displacement amount at the time of start of the ABS control operation. The active control target value which is a control target value of the assist member active control is corrected with use of the pedal displacement amount. Timing of update of the pedal displacement amount is regulated by the timer.

In other words, a change in the input signal is limited by delaying transmission of the signal of the displacement sensor 7, whereby vibration of the control system is restrained. That is, a delay element is provided to the input signal, so that stabilization of the control system is achieved. In the feedback control loop, responsiveness of the control system to a target value is adjusted according to the control gain. Therefore, for example, vibration of the control system may be restrained by changing the control gain of the servo control unit dl such that the responsiveness is reduced.

### Second Embodiment

A second embodiment of the present invention will now be described. Since the second embodiment has basically same structure and configuration as those of the first embodiment, only features different from or absent in the first embodiment will be described.

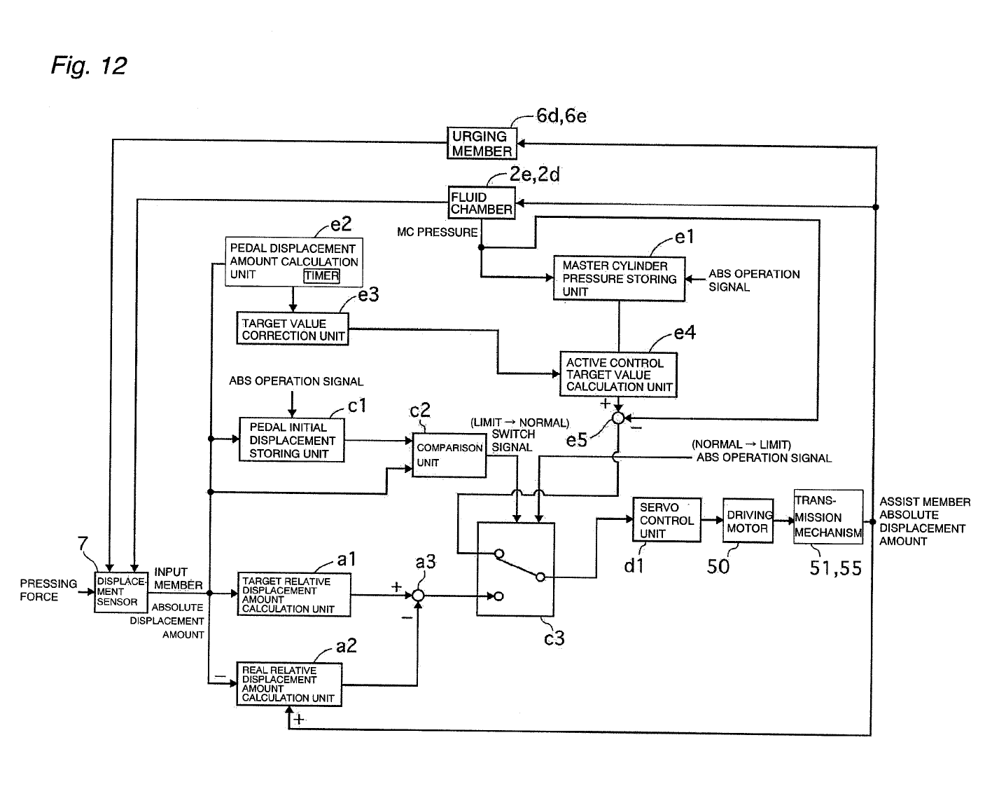

FIG. 12 is a block diagram illustrating a control configuration of the second embodiment. Since the configuration of the normal boosting control (assist member passive control) that is a basic control, and the control switching process in the second embodiment are the same as those in the first embodiment, the detailed descriptions thereof will not be repeated. In the first embodiment, the displacement of the input member is restrained by limiting the position of the assist member within the predetermined range. On the other hand, in the second embodiment, a controlled object is the master cylinder pressure.

Now, a description will be given as to the configuration of the assist member active control for limiting the range within which the assist member can be displaced when the ABS control is performed. The master cylinder pressure sensors 3a and 3b are collectively referred to as “master cylinder pressure sensor”.

### [Assist Member Active Control]

At a master cylinder pressure storing unit e1, a master cylinder pressure sensor signal and the ABS operation signal from the wheel cylinder pressure control apparatus 9 are received as input, and the master cylinder pressure at the time of input of the ABS operation signal is stored.

At a pedal displacement amount calculation unit e2, a displacement amount of the input member absolute displacement amount is updated and stored each time the timer count reaches a predetermined timer value.

At a target value correction unit e3, a target value set in the assist member active control is corrected according to the pedal displacement amount calculated at the pedal displacement amount calculation unit e2.

At an active control target value calculation unit e4, the value resulting from addition of a predetermined offset value to the master cylinder pressure stored at the master cylinder pressure storing unit e1 is set as an initial master cylinder pressure target value, and the value corrected according to an instruction from the target value correction unit e3 is output as a final master cylinder pressure active control target value. It should be noted that a value that does not exceed a detection acceptable value of the master cylinder pressure sensor is set as the active control target value, and if the master cylinder pressure stored at the master cylinder pressure storing unit e1 exceeds the detection acceptable value, a certain value that is a maximum value is set as the active control target value.

The offset value is added to the stored master cylinder pressure so that brake fluid can be sufficiently supplied from the master cylinder side when a pressurizing control is performed after a depressurizing control is performed due to the ABS control. For example, an amount of back-flowing fluid may be estimated based on vale-opening time of the depressurizing valves 14, 15, 24 and 25 when the ABS control is performed. It may be determined that a depressurized amount is large when the depressurization time is equal to or more than a predetermined time, and the amount of back-flowing fluid is large accordingly, whereby the offset value may be changed to a larger value. It can be estimated that, if a depressurized amount is large, an amount of brake fluid back-flowing to the master cylinder is large accordingly. Therefore, a need to largely displace the assist member when brake fluid back-flows are eliminated by setting a high active control target value. That is, it is possible to reduce a displacement amount of the assist member.

Further, the amount of back-flowing fluid may be estimated based on the combination of the operation times of the depressurizing valve and the pressurizing valve. In an embodiment in which a target fluid pressure of the ABS control is calculated, the amount of back-flowing fluid may be estimated based on the deviation between the target fluid pressure of the ABS control and the current wheel cylinder pressure. In an embodiment comprising a reservoir model for estimating a brake fluid amount flowing into the reservoirs 16 and 26, the amount of back-flowing fluid may be estimated based on the brake fluid amount flowing into the reservoir model.

At an active control deviation calculation unit e5, a deviation between the active control target value set at the active control target value calculation unit e4 and the master cylinder pressure detected by the master cylinder pressure sensor is calculated. The calculated deviation is output to the switch unit c3 which will be described later. When the assist member active control is selected at the switch unit c3, the following procedure is performed.

At the servo control unit dl, the servo control is performed by feedback based on the deviation calculated at the active control deviation calculation unit e5. An electric instruction value to be supplied to the driving motor 50 is calculated, and is output to the driving motor 50. The electric current output into the driving motor 50 causes the driving motor 50 to rotate, and the generated rotational power is converted into a translational power through the transmission mechanism, which causes the assist member to move forward and backward. In particular, if the active control target value is higher than the master cylinder pressure, the assist member is displaced forward, and if the active control target value is lower than the master cylinder pressure, the assist member is displaced backward.

In the assist member active control, gains different from the control gains Kp, Ki and Kd in the assist member passive control are set, and a control amount is output in consideration of the P-Q characteristic. The P-Q characteristic is a characteristic indicating the relationship between the fluid pressure and the fluid amount, and suggesting how much fluid amount should be changed for changing the master cylinder pressure. Determination of the fluid amount makes it possible to determine the stroke amount of the assist member and the input member.

### [Control Switching Process]

The switching process for switch between the assist member passive control and the assist member active control will now be described. At the pedal initial displacement storing unit c1, the input member absolute displacement amount and the ABS operation signal from the wheel cylinder pressure control apparatus 9 are received as input, and the value resulting from subtraction of a predetermined offset value from the input member absolute displacement amount at the time of input of the ABS operation signal is stored.

At the comparison unit c2, the current input member absolute displacement amount is compared with the value resulting from subtraction of the predetermined offset value from the stored pedal initial displacement, and if the brake pedal BP is returned by a driver, an instruction for switch from the assist member active control to the assist member passive control is output.

At the switch unit c3, the control mode is switched based on the ABS operation signal and the switch signal from the comparison unit c2. If the ABS operating signal is input, then the control mode is switched from the assist member passive control to the assist member active control. If the instruction signal is input from the comparison unit c2, then the control mode is switched from the assist member active control to the assist member passive control.

### [Reason and Mechanism of Assist Member Active Control]

The relationship between driver's pressing force input into the displacement sensor 7, and the fluid chambers 2e and 2d and the urging members 6d and 6e will now be described. In the control configuration of the first embodiment, when the assist member is actuated by the driving motor 50, the influence is exerted on the fluid chambers 2e and 2d, in addition to the input member through the urging member. Since the input member is disposed so as to face the fluid chambers 2e and 2d, and is elastically coupled with the assist member through the urging member, the influence exerted on the fluid chambers 2e and 2d is also exerted on the input member through a change in the fluid pressure. In addition, since the input member is displaced by an input of driver's pressing force, the value detected by the displacement sensor 7 shows the influence based on driver's pressing force, and the influence based on the assist member operation.

As mentioned above, in the assist member passive control that is a normal control, the displacement of the input member caused by driver's pressing force is detected, and the displacement of the assist member is controlled according to the displacement of the input member. At this time, the control gain is set so as not to cause vibration of the control system in order to achieve stabilization of the control system.

When the ABS control is performed in the wheel cylinder pressure control apparatus 9, the brake fluid discharged from the wheel cylinder by depressurization back-flows to the master cylinder side, and the influence thereof is exerted on the fluid chambers 2e and 2d. Then, the influence is also exerted on the displacement sensor 7 through the input member, bringing about an effect that is different from the effect originally expected in the assist member passive control, whereby disturbance would occur in the control system.

Since it is expected that the depressurization operation is performed intermittently and is repeated per extremely short cycle, the influence by the back-flow of the brake fluid to the master cylinder side is as follows. There is a time lag between a change in the fluid pressure caused in the fluid chambers 2e and 2d, and a change in the detection value of the displacement sensor 7. Even though the displacement of the assist member is controlled accordingly, a change in the fluid chambers 2e and 2d due to the back-flowing brake fluid, and a change in the fluid chambers 2e and 2d due to the control of the assist member interfere with each other, so that vibration of the whole control system may be caused. Due to this vibration, the input member may be largely displaced forward and backward, whereby the driver may have a strange and discomfort feeling.

Therefore, in the second embodiment, when the ABS control operation is detected, the control mode is switched from the assist member passive control based on a detection value of the displacement sensor 7 to the assist member active control. The active control target value is set such that it does not have delay as a control phase from disturbance acting on the fluid chambers 2e and 2d, unlike the detection value of the displacement sensor 7, and a feedback control is performed.

In particular, a feedback loop is formed in which the value resulting from addition of the predetermined offset value to the master cylinder pressure at the time of start of the ABS control is set as a target value. As a result, fluctuation of the target value can be prevented. In addition, the feedback loop is formed with use of the detection value of the master cylinder pressure sensor. The signal of the displacement sensor 7 has a delaying control phase since the displacement follows a change in the pressure. Instead of using the signal of the displacement sensor 7, use of the signal of the master cylinder pressure sensor, which has a leading control phase, makes the control stable.

As a result, vibration of the control system is restrained, and therefore displacement of the assist member is limited. The influence of the brake fluid back-flowing to the master cylinder side affects the assist member and the input member. Since the pair of springs 6d and 6e (urging member) is disposed between the assist member and the input member to serve to maintain them at the neutral position of the relative displacement between them, displacement of the assist member for absorbing a change in the master cylinder pressure causes the input member to also be displaced accordingly.

However, since the master cylinder pressure to act on the input member is not changed after the assist member active control is selected, the relative displacement amount between the assist member and the input member become constant, and therefore vibration by a change in the relative displacement amount is prevented. Therefore, it is possible to reduce a strange and discomfort feeling that is provided to the driver. In addition, a slight vibration is still produced, and this slight vibration can indicate to the driver that the ABS control operation is being performed.

Further, as mentioned above, according to the assist member active control, the input member absolute displacement amount is slightly changed due to pressurization/depressurization operation of the ABS control, but this change does not affect the control system since the input member absolute displacement amount is not used as an input signal in the assist member active control.

However, not using the absolute displacement amount of the input member as input information means that no information based on a brake pedal operation is used in the assist member active control. As a result, it is impossible to accept displacement of the input member according to a brake pedal operation of a driver, and the input member is not returned when the driver returns the brake pedal during the ABS control. For solving this problem, the detection value of the displacement sensor 7 is updated based on the predetermined timer value, i.e., the phase of a signal of the displacement sensor 7 is delayed to be detected, and correction of the active control target value, and switch from the assist member active control to the assist member passive control are performed according to a change amount of a detection value of the displacement sensor 7.

Now, a control process according to the above-mentioned control configuration of the second embodiment will be described with reference to a flow chart for better understanding. Since the basic control structure and the assist member passive control of the second embodiment are the same as the basic control structure and the assist member passive control of the first embodiment which are respectively shown in FIG. 3 and FIG. 4, the descriptions thereof will not be repeated.

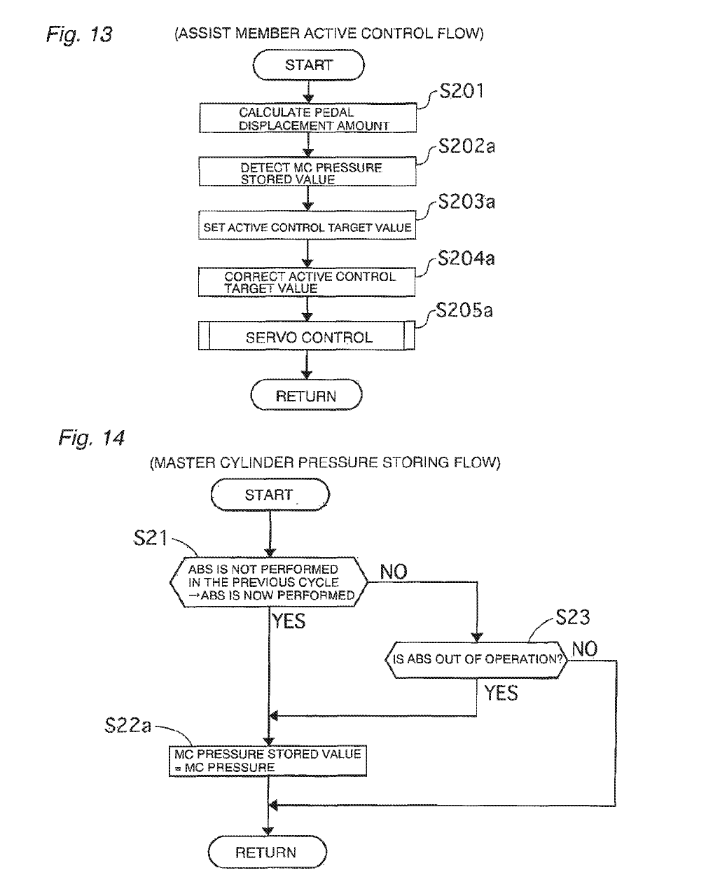

FIG. 13 is a flow chart illustrating a basic control configuration of the assist member active control. At step S201, the pedal displacement amount is calculated, and this process is the same as the pedal displacement amount calculating process of the first embodiment shown in FIG. 6. At step S202a, the master cylinder pressure at the time of start of the ABS control is stored. At step S203a, the active control target value is set by adding the predetermined offset value to the stored master cylinder pressure. At step S204a, the active control target value is corrected based on the pedal displacement amount when the operation amount of the brake pedal operation amount is changed during the current assist member active control. At step S205a, the servo control is performed to control the assist member such that the master cylinder pressure becomes equal to the set active control target value.

FIG. 14 is a flow chart illustrating the master cylinder pressure storing process performed at step S202a shown in FIG. 13. At step S21, it is determined whether the condition is changed from the condition in which the ABS control is not performed in the previous control cycle, to the condition in which the ABS control is performed in the current control cycle. If the condition is changed, then the flow proceeds to step S22a; if not, the flow proceeds to step S23. At step S22a, the master cylinder pressure currently detected by the master cylinder pressure sensor is stored as a master cylinder pressure stored value. At step S23, it is determined whether the ABS control is out of operation. If the ABS control is out of operation, then the flow proceeds to step S22a, and the current master cylinder pressure is stored as the stored value; if the ABS control is in operation, then update of the stored value is prohibited, and the current control flow is ended.

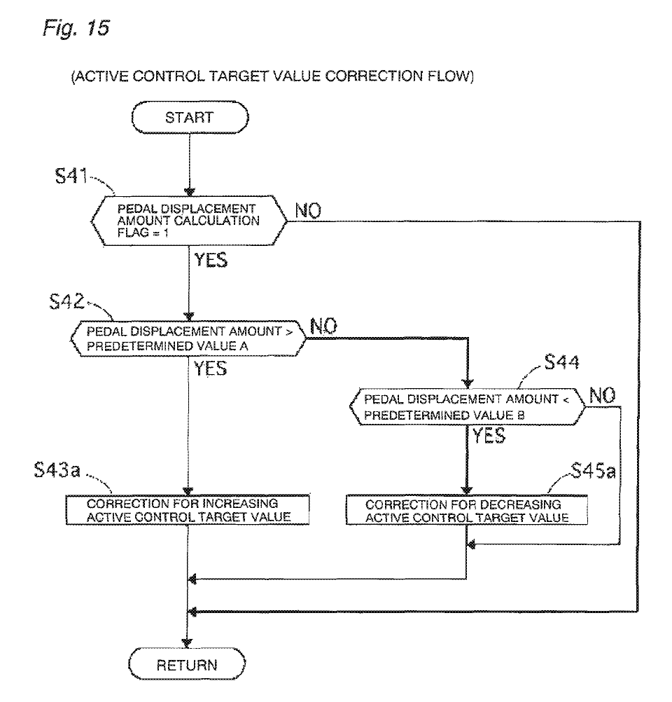

FIG. 15 is a flow chart illustrating the active control target value setting process performed at step S204a shown in FIG. 13. At step S41, it is determined whether the pedal displacement amount calculation flag, which is set in the flow chart shown in FIG. 6, is 1. If the flag is 1, then it is determined that the pedal displacement amount should be updated, and the flow proceeds to step S42; if the flag is 0, then it is determined that update of the pedal displacement amount is prohibited, and the current control flow is ended.

At step S42, it is determined whether the updated pedal displacement amount is larger than a predetermined value A. If the updated pedal displacement amount is larger than the value A, then the flow proceeds to step S43a; if not, the flow proceeds to step S44. The predetermined value A should be within a range for making it possible to detect a condition of driver's brake pedal operation with sufficiently excellent responsiveness, and preventing vibration of the control system.

At step S43a, it is determined that the brake pedal is pressed down by the driver, and the active control target value is calculated by correcting the active control target value (the sum of the offset value and the master cylinder pressure stored at the time of start of the ABS control, or the corrected active control target value) to a value causing the master cylinder pressure to further increase.

At step S44, it is determined whether the pedal displacement amount is less than a predetermined value B. If the pedal displacement amount is less than the value B, then the flow proceeds to step S45a; if not, it is determined that a pedal operation is not performed and the current control flow is ended.

At step S45a, it is determined that the brake pedal is returned by the driver, and the active control target value is calculated by correcting the active control target value (the sum of the offset value and the master cylinder pressure stored at the time of start of the ABS control, or the corrected active control target value) to a value causing the master cylinder pressure to decrease.

The control switching process of the second embodiment is same as the control switching process of the first embodiment shown in FIG. 9, which is performed at the pedal initial displacement storing unit c1, the comparison unit c2, and the switch unit c3. The pedal initial displacement detecting process of the second embodiment is the same as the pedal initial displacement detecting process of the first embodiment shown in FIG. 10. Therefore, descriptions about them will not be repeated.

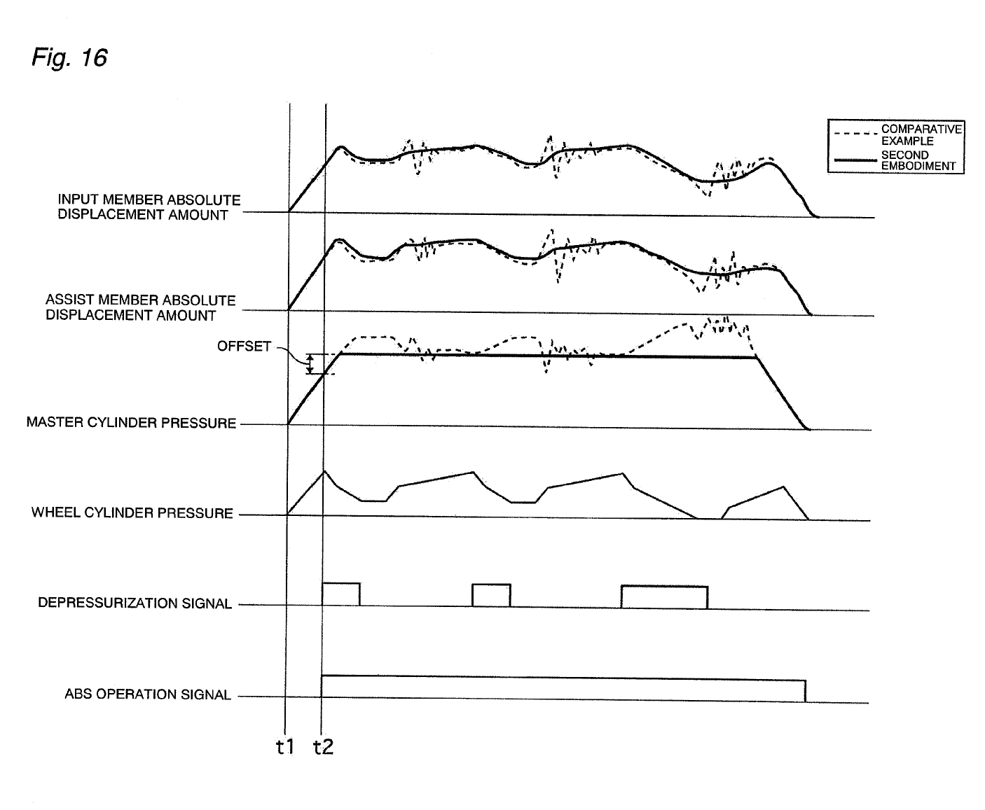

The operation according to the above-mentioned control flow will now be described. FIG. 16 is a time chart illustrating the assist member active control during the ABS control in the second embodiment. In FIG. 16, the bold solid line indicates an operation in the second embodiment, and the thin dotted line indicates an operation in a comparative example in which the control switch is not performed.

At time t1, the assist member passive control remains selected. Therefore, when the driver starts to press down the brake pedal BP, the input member starts a stroke, and the assist member is displaced accordingly. In addition, the master cylinder pressure is generated according to the currently selected boosting ratio, and the wheel cylinder pressure starts to increase accordingly.

At time t2, since a slip rate of the wheel exceeds a predetermined value and therefore the ABS control is started, a depressurization signal is output in the wheel cylinder pressure control mechanism 3, and the brake fluid is discharged from the wheel cylinder to the reservoir. At the same time, the discharged brake fluid back-flows to the master cylinder side with the aid of the driven pumps P1 and P2. On the other hand, in the master cylinder pressure control mechanism 5, the control mode is changed from the assist member passive control to the assist member active control at the time of input of the ABS operation signal, and the value resulting from addition of the offset value and the master cylinder pressure stored at the time of input of the ABS operation signal by the process of step S203a shown in FIG. 13 is set as the active control target value.

Simultaneously, the value resulting from subtraction of the predetermined offset value from the input member absolute displacement amount at the time of start of the ABS control is stored as the pedal initial position, and count-up of the timer for calculating the pedal displacement amount is started.

While the ABS control continues, the feedback control is performed such that, basically, the master cylinder pressure is kept at the active control target value by the servo control process performed at step S205a shown in FIG. 13. At this time, although the master cylinder pressure is expected to increase according to the amount of the brake fluid back-flowing due to the ABS control, the master cylinder pressure is not changed according to the amount of the back-flowing brake fluid since the assist member is controlled such that the forward and backward displacement of the assist member prevents a change in the master cylinder pressure. However, the input member coupled to the assist member through the urging member is displaced according to the forward and backward displacement of the assist member, although the amount of the relative displacement between the input member and the assist member is not changed since the master cylinder pressure is kept constant. However, the assist member is not controlled according to displacement of the input member, and therefore vibration of the control system can be restrained even if the input member is displaced.

After that, this control condition continues. The brake fluid back-flows to the master cylinder side each time the depressurizing control for the ABS control is performed, and the assist member and the input member are displaced forward and backward accordingly.

On the other hand, in the comparative example, a change in the master cylinder pressure due to the back-flowing brake fluid causes the input member absolute displacement amount to be changed, and therefore the assist member absolute displacement amount to be changed accordingly. Sine the assist member and the input member are coupled to each other through the urging member, the force when the assist member is displaced is input to the input member. After that, repeat of this change results in vibration of the control system and a large change in the input member absolute displacement amount, giving a strange and discomfort feeling to the driver. On the other hand, in the second embodiment, it is possible to restrain vibration of the control system and also reduce a change in the input member absolute displacement amount caused by the vibration by switching the control mode to the assist member active control so as to perform the feedback control based on the master cylinder pressure having a leading control phase.

Here are advantageous effects brought about by the creation of the technical idea according to the second embodiment.

(1) The second embodiment of the present invention comprises the assist member disposed so as to be movable relative to the input member movable forward and backward according to an operation of the brake pedal BP, the urging member operable to urge the input member relative to the assist member toward the neutral position of the relative displacement between the assist member and the input member, the booster (master cylinder pressure control apparatus 5) operable to pressurize the inside of the master cylinder by displacing the assist member, the control unit (master cylinder pressure control apparatus 8) operable to control the actuator (driving motor 50) operable to drive the assist member according to the predetermined input signal, and the fluid pressure control unit (wheel cylinder pressure control mechanism 3 and the wheel cylinder pressure control apparatus 9) disposed between the master cylinder 2 and the wheel cylinder 4. The control unit (master cylinder pressure control apparatus 8) switches the type of the predetermined input signal for driving the actuator (driving motor 50) according to an operation condition of the fluid pressure control unit (wheel cylinder pressure control mechanism 3 and the wheel cylinder pressure control apparatus 9).

As a result, stabilization of the control system can be achieved by switching the type of the input signal when destabilization of the control system is expected from an operation condition of the fluid pressure control unit.

(2) As the predetermined input signal, a stroke amount of the input member (input member absolute displacement amount) is used when the fluid pressure control unit is not in operation, and a signal according to a pressure in the master cylinder is used when the fluid pressure control unit is in operation. That is, when the fluid pressure control unit is not in operation, the assist member is controlled with use of the input member absolute displacement amount so that an intention of a driver can be maximally reflected. When the fluid pressure control unit is in operation, in consideration of influence to be exerted on the control system by the fluctuant displacement of the input member caused by the operation of the fluid pressure control unit, the master cylinder pressure which has a leading control phase is used as the predetermined input signal, whereby a stable pedal feeling can be provided.
(3) The operation of the fluid pressure control unit (wheel cylinder pressure control mechanism 3 and wheel cylinder pressure control apparatus 9) is the operation of the anti-lock brake control (ABS control operation). The control unit (master cylinder pressure control apparatus 8) stores as a target value a value based on the master cylinder pressure at the time of start of the anti-lock brake control, and controls the assist member such that the master cylinder pressure becomes equal to the stored target value.

As a result, even though the brake fluid back-flows due to the ABS control operation, and the input member and the assist member are displaced for absorbing the change in the master cylinder pressure due to the back-flowing brake fluid, the master cylinder pressure is controlled so as to become equal to the stored master cylinder pressure without using the information of the input member, whereby vibration of the control system can be restrained, and an excellent pedal feeling can be provided.

(11) According to one embodiment of the present invention, a brake booster comprises the input member movable forward and backward according to an operation of the brake pedal BP, the assist member disposed so as to be movable relative to the input member in the moving direction of the input member, the urging member operable to urge the input member relative to the assist member toward the neutral position of the relative displacement between the assist member and the input member, the actuator (driving motor 50) operable to displace forward and backward the assist member, the control unit (master cylinder pressure control apparatus 8) operable to control the driving motor 50, the booster (master cylinder pressure control apparatus 5) operable to generate a pressurized brake fluid pressure inside the master cylinder by a thrust force generated by displacing the assist member, and the fluid pressure control unit (wheel cylinder pressure control mechanism 3 and the wheel cylinder pressure control apparatus 9) disposed between the master cylinder 2 and the wheel cylinder 4. The fluid pressure control unit discharges the brake fluid in the wheel cylinder 4 and causes the discharged brake fluid to back-flow to the master cylinder 2 when a slip condition of the wheel is detected. The master cylinder pressure control apparatus 8 performs the assist member passive control and the assist member active control. In the assist member passive control, the driving motor 50 is controlled such that the assist member is displaced forward and backward according to a displacement amount of the input member. In the assist member active control, while the fluid pressure control unit (wheel cylinder pressure control mechanism 3 and the wheel cylinder pressure control apparatus 9) is in operation, the displacement amount of the assist member is controlled based on the master cylinder pressure.

As a result, even when the brake fluid backflows to the master cylinder side due to an operation of the fluid pressure control unit and the back-flowing brake fluid affects the assist member, the displacement amount of the assist member is limited based on the master cylinder pressure, whereby pulsation and pedal vibration can be restrained and an excellent pedal feeling can be provided.

(12) The input member and the assist member are disposed so as to face the first chamber (primary fluid chamber 2d) on which the master cylinder pressure acts, and the pressure-receiving area of the input member is smaller than that of the assist member. Therefore, it is possible to absorb a change in the master cylinder pressure due to the back-flowing brake fluid only by slightly displacing forward and backward the assist member, whereby the displacement of the input member can be reduced.
(13) The control unit (master cylinder pressure control apparatus 8) and the fluid pressure control unit (wheel cylinder pressure control apparatus 9) are connected with each other through the communication line L. Therefore, they can exchange various information.
(14) The control unit (master cylinder pressure control apparatus 8) receives a operating condition of the fluid pressure control unit (wheel cylinder pressure control apparatus 9) from the fluid pressure control unit (wheel cylinder pressure control apparatus 9) through the communication line L, thereby capable of quickly detecting information of the fluid pressure control unit.
(15) The control unit (master cylinder pressure control apparatus 8) performs the assist member active control when it receives a operating condition of the fluid pressure control unit (wheel cylinder pressure control apparatus 9). Therefore, the control unit can start the assist member active control in advance as early as some influence is expected to affect the master cylinder side, whereby the pedal feeling can be further improved.
(16) A value based on the master cylinder pressure at the time of start of an operation of the fluid pressure control unit is stored as the target value, and the displacement amount of the assist member is controlled such that the master cylinder pressure becomes equal to the stored target value.

That is, a feedback control is performed based on the master cylinder pressure having a leading control phase, whereby vibration of the control system can be restrained and a change in the input member absolute displacement amount due to the vibration can be reduced.

According to one embodiment of the present invention, a brake booster comprises the assist member disposed so as to be movable relative to the input member movable forward and backward according to an operation of the brake pedal BP, the urging member operable to urge the input member relative to the assist member toward the neutral position of the relative displacement between the assist member and the input member, the booster (master cylinder pressure control apparatus 5) operable to pressurize the inside of the master cylinder by displacing the assist member, the control unit (master cylinder pressure control apparatus 8) operable to control the actuator (driving motor 50) operable to drive the assist member according to the input signal, and the fluid pressure control unit (wheel cylinder pressure control mechanism 3 and the wheel cylinder pressure control apparatus 9) disposed between the master cylinder 2 and the wheel cylinder 4. The control unit (master cylinder pressure control apparatus 8), when the fluid pressure control unit is in operation, switches the type of the input signal to the input signal having a less phase delay than the input signal used when the fluid pressure control unit is not in operation.

In particular, the master cylinder pressure is used as the input signal, instead of the displacement amount of the input member that is not displaced until the master cylinder pressure is changed. Therefore, vibration of the control system can be effectively restrained.

Having described the first and second embodiments of the present invention, the present invention may be embodied by other embodiments. For example, in some embodiments, the input member absolute displacement value at the time of start of the ABS control may be stored, and the stored input member absolute displacement amount may be set as a fixed value. Then, the master cylinder pressure may be detected, and the boosting ratio corresponding to the current master cylinder pressure and the fixed input member absolute displacement amount may be calculated from the relationship between the input member absolute displacement amount and the master cylinder fluid pressure shown in FIG. 4C. Based on the fixed input member absolute displacement amount and the calculated boosting ratio, the relative displacement amount may be calculated from the graph of FIG. 4B. The target displacement amount of the assist member may be set based on the fixed input member absolute displacement amount and the relative displacement amount, and the assist member may be controlled by the feedback control accordingly.

That is, when brake fluid back-flows to the master cylinder side, the master cylinder pressure is expected to increase. Controlling the assist member by changing the boosting ratio according to the condition makes it possible to absorb by the urging member the force for increasing the master cylinder pressure to act on the input member, whereby the displacement of the input member can be restrained and an excellent pedal feeling can be provided.

Although the input member is slightly displaced, since the position of the input member is stored as a fixed value, and the assist member is controlled according to a change in the master cylinder pressure, vibration of the control system due to a change in the input member absolute displacement amount caused by the control of the assist member can be restrained.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention. Moreover, all features of all embodiments and all claims can be combined with each other, as long as they do not contradict each other.

The present application claims priority under 35 U.S.C. section 119 to Japanese Patent Application No. 2008-097117, filed on Apr. 3, 2008. The entire disclosure of Japanese Patent Application No. 2008-097117 including specification, claims, drawings and summary is incorporated herein by reference in its entirety.

What is claimed is:

1. A brake booster, comprising:
an assist member disposed so as to be movable relative to an input member movable forward and backward according to an operation of a brake pedal;
a booster operable to pressurize an inside of a master cylinder by displacing the assist member;
a control unit operable to control an actuator operable to drive the assist member according to a predetermined input signal; and
a fluid pressure control unit disposed between the master cylinder and a wheel cylinder,
wherein the control unit switches a type of the predetermined input signal for driving the actuator according to an operation condition of the fluid pressure control unit.

2. The brake booster according to claim 1, further comprising a displacement sensor operable to detect a stroke amount of the input member, and a master cylinder pressure sensor operable to detect a master cylinder pressure,
wherein a signal based on the stroke amount of the input member detected by the displacement sensor is used as the predetermined input signal when the fluid pressure control unit is not in operation, and a signal based on a pressure in the master cylinder detected by the master cylinder pressure sensor is used as the predetermined input signal when the fluid pressure control unit is in operation.

3. The brake booster according to claim 2, wherein:
an operation of the fluid pressure control unit is an operation of an anti-lock brake control; and
the control unit stores a value based on the master cylinder pressure at the time of start of the anti-lock brake control as a target value, and performs a control such that the master cylinder pressure becomes equal to the stored target value.

4. The brake booster according to claim 3, wherein, in the assist member active control, the target value is corrected according to a change in an operation of the brake pedal during the control.

5. The brake booster according to claim 1, wherein the input member and the assist member are disposed so as to face a first chamber on which a master cylinder pressure acts, and a pressure-receiving area of the input member is smaller than a pressure-receiving area of the assist member.

6. The brake booster according to claim 1, wherein the control unit and the fluid pressure control unit are connected with each other through a communication line.

7. The brake booster according to claim 6, wherein the control unit receives an operation condition of the fluid pressure control unit from the fluid pressure control unit through the communication line.

8. The brake booster according to claim 5, wherein the control unit is connected to a master cylinder pressure sensor operable to detect the master cylinder pressure, stores a value based on the master cylinder pressure as a target value when the control unit receives an operation condition of the fluid pressure control unit, and performs an assist member active control in which a displacement amount of the assist member is controlled such that the master cylinder pressure becomes equal to the stored target value.

9. The brake booster according to claim 1, wherein:
an operation of the fluid pressure control unit is an operation of an anti-lock brake control; and
the control unit is connected to a master cylinder pressure sensor operable to detect a master cylinder pressure, stores a value based on the master cylinder pressure at the time of start of the anti-lock brake control as a target value, and performs a control such that the master cylinder pressure becomes equal to the stored target value.

10. The brake booster according to claim 9, wherein, in the assist member active control, the target value is corrected according to a change in an operation of the brake pedal during the control.

11. A brake booster, comprising:
an input member movable forward and backward according to an operation of a brake pedal;
an assist member disposed so as to be movable relative to the input member in a moving direction of the input member;
an urging member operable to urge the input member relative to the assist member to a neutral position of relative displacement between the assist member and the input member;
an actuator operable to displace forward and backward the assist member;
a control unit operable to control the actuator;
a booster operable to generate a pressurized brake fluid pressure in a master cylinder by a thrust force generated by displacement of the assist member;
a fluid pressure control unit which is disposed between the master cylinder and a wheel cylinder, and which discharges brake fluid in the wheel cylinder when a slip condition of a wheel is detected, and causes the discharged brake fluid to back-flow to the master cylinder; and
a master cylinder pressure sensor operable to detect a master cylinder pressure,
wherein the control unit performs an assist member passive control in which the assist member is displaced forward and backward according to a displacement amount of the input member by driving the actuator, and an assist member active control in which a displacement amount of the assist member is controlled according to the master cylinder pressure when the fluid pressure control unit is in operation.

12. The brake booster according to claim 11, wherein:
the input member and the assist member are disposed so as to face a first chamber on which the master cylinder pressure acts; and
a pressure-receiving area of the input member is smaller than a pressure-receiving area of the assist member.

13. The brake booster according to claim 11, wherein the control unit and the fluid pressure control unit are connected with each other through a communication line.

14. The brake booster according to claim 13, wherein the control unit receives an operation condition of the fluid pressure control unit from the fluid pressure control unit through the communication line.

15. The brake booster according to claim 4, wherein the control unit performs the assist member active control when the control unit receives the operation condition of the fluid pressure control unit.

16. The brake booster according to claim 11, wherein:
an operation of the fluid pressure control unit is an operation of an anti-lock brake control; and
the control unit stores a value based on the master cylinder pressure at the time of start of the anti-lock brake control as a target value, and performs a control such that the master cylinder pressure becomes equal to the stored target value.

17. The brake booster according to claim 16, wherein, in the assist member active control, the target value is corrected according to a change in an operation of the brake pedal during the control.

18. A brake booster, comprising:
an input member movable forward and backward according to an operation of a brake pedal;
an assist member disposed so as to be movable relative to the input member in a moving direction of the input member;
an actuator operable to displace forward and backward the assist member;
a control unit operable to control the actuator;
a booster operable to generate a pressurized brake fluid pressure in a master cylinder by a thrust force generated by displacement of the assist member;
a master cylinder pressure sensor operable to detect a master cylinder pressure; and
a fluid pressure control unit which is disposed between the master cylinder and a wheel cylinder, and which discharges brake fluid in the wheel cylinder when a slip condition of a wheel is detected, and causes the discharged brake fluid to back-flow to the master cylinder,
wherein the control unit performs an assist member passive control in which the assist member is displaced forward and backward according to a displacement amount of the input member by driving the actuator, and an assist member active control in which a displacement amount of the assist member is controlled according to the master cylinder pressure when an anti-lock brake control of the fluid pressure control unit is in operation.

19. The brake booster according to claim 18, wherein the control unit stores a value based on the master cylinder pressure at the time of start of the anti-lock brake control as a target value, and performs a control such that the master cylinder pressure becomes equal to the stored target value.

20. The brake booster according to claim 19, wherein, in the assist member active control, the target value is corrected according to a change in an operation of the brake pedal during the control.
